(19) United States
(12) Patent Application Publication
(10) Pub. No.: US 2014/0313581 A1
(43) Pub. Date: Oct. 23, 2014

(54) LONG PATTERNED ALIGNMENT FILM, AND LONG PATTERNED RETARDATION FILM USING SAME

(71) Applicants: Keiji Kashima, Tokyo-to (JP); Hiroyuki Nishimura, Tokyo-to (JP); Masanori Fukuda, Tokyo-to (JP); Yuugo Noritake, Tokyo-to (JP)

(72) Inventors: Keiji Kashima, Tokyo-to (JP); Hiroyuki Nishimura, Tokyo-to (JP); Masanori Fukuda, Tokyo-to (JP); Yuugo Noritake, Tokyo-to (JP)

(73) Assignee: DAI NIPPON PRINTING CO., LTD., Tokyo-to (JP)

(21) Appl. No.: 14/351,718

(22) PCT Filed: Sep. 13, 2012
(86) PCT No.: PCT/JP2012/073507

§ 371 Date: Apr. 14, 2014

(30) Foreign Application Priority Data
Mar. 1, 2012 (JP) 2012-045433

(51) Int. Cl. G02F 1/1337; G02B 1/10; G02B 1/11; G02B 5/30

(52) U.S. Cl. CPC G02F 1/133711; G02B 5/3083; G02B 1/10; G02B 1/11
USPC 359/489.07; 359/601; 428/1.2

(57) ABSTRACT

A long patterned alignment film is provided, from which a large number of patterned retardation films can easily be produced, having an alignment layer which is in a long form and comprises an optical alignment material, wherein the alignment layer includes a first alignment region for causing a rodlike compound having a refractive index anisotropy to be arranged in a certain direction, and a second alignment region for causing the rodlike compound to be arranged in a direction different from the certain direction of the first alignment region.

### TECHNICAL FIELD

The present invention relates to a long patterned alignment film from which a large number of patterned retardation films can be easily produced.

### BACKGROUND ART

As flat panel displays, two-dimensional displaying type displays have hitherto been in the main current. In recent years, however, flat panel displays capable of attaining three-dimensional displays have been coming to public notice. Such known displays have partially been commercially available. Future flat panel displays have a tendency of being naturally required to have the ability of attaining three-dimensional displays. Thus, in various fields, studies have been advanced about flat panel displays capable of attaining three-dimensional displays.

In order to cause a flat panel display to attain three-dimensional displays, it is usually necessary to display, for any viewer, an image for his/her right eye and an image for his/her left eye separately from each other in some mode. As a method for displaying an image for the right eye and an image for the left eye separately from each other, for example, a passive mode is known. With reference to a figure, the three-dimensional display mode of the passive mode is described. FIG. 19 is a schematic view illustrating an example of passive mode three-dimensional display. As illustrated in FIG. 19, in this mode, pixels constituting a flat panel display are initially divided patternwise into two-type pixels, that is, image-displaying pixels for the right eye and image-displaying pixels for the left eyes. In the pixels in one of the two groups, an image for the right eye is displayed while in those in the other group, an image for the left eye is displayed. The image for the right eye and that for the left eye are converted into circularly polarized light rays orthogonal to each other by use of a linearly polarizing plate, and a patterned retardation film in which a patterned retardation layer corresponding to the pattern of the division of the pixels is formed. Furthermore, any viewer is let to put circularly polarizing glasses on, in which circularly polarizing lenses for generating circularly polarized rays orthogonal to each other are adopted as a lens for the right eye and a lens for the left eye. Thus, the image for the right eye is passed through only the lens for the right eye while the image for the left eye is passed through only the lens for the left eye. In this way, the image for the right eye reaches only viewer's right eye while the image for the left eye reaches only viewer's left eye. A mode that any three-dimensional display can be attained in this way is the passive mode.

The passive mode has an advantage that three-dimensional displays can easily be attained by the use of a patterned retardation film as described above and circularly polarizing glasses matched therewith.

As described above, in the passive mode, it is essential to use a patterned retardation film. However, about such patterned retardation films, broad researches and developments have not yet been made so that standard techniques thereof have not been established in the present circumstances. In connection therewith, Patent Literature 1 discloses, as a patterned retardation film, a patterned retardation plate comprising a glass substrate, a photo alignment layer thereon in which alignment regulating force is patternwise controlled, and a retardation layer formed on the photo alignment layer and containing a liquid crystal compound the arrangement of which is patterned correspondingly to the pattern of the photo alignment layer. However, it is essential to use a glass plate in such a patterned retardation plate as disclosed in Patent Literature 1. Thus, the retardation plate is expensive. Moreover, the technique disclosed therein does not make it possible to produce a large number of retardation plates each having a large area. Consequently, it is difficult to put the technique into practical use.

For such reasons, patterned retardation films having practicability have still been at the stage of research and development, and almost all thereof have not been known as popular articles. As a result, there remains a problem that display devices have not been gained which can be produced in large number at low costs by a simple method, and can display three-dimensional images.

### CITATION LIST

### Patent Literature

Patent Literature 1: Japanese Patent Application Publication (JP-A) No. 2005-049865

### SUMMARY OF INVENTION

### Technical Problem

The present invention has been made in light of such situations, and a main object thereof is to provide a long patterned alignment film from which a large number of patterned retardation films can easily be produced.

### Solution to Problem

In order to solve the above-mentioned problems, the present invention provides a long patterned alignment film, comprising an alignment layer which is in a long form and comprises an optical alignment material, wherein the alignment layer comprises a first alignment region for causing a rodlike compound having a refractive index anisotropy to be arranged in a certain direction, and a second alignment region for causing the rodlike compound to be arranged in a direction different from the certain direction of the first alignment region.

According to the invention, the long patterned alignment film has the first and second alignment regions, and this matter makes it possible that by action of applying the rodlike compound thereto, a retardation layer is easily formed which has a first retardation region and a second retardation region in which the respective arranging directions of the rodlike compound are different from each other.

Moreover, the patterned alignment film is in a long form, and this form makes it possible to form easily a long patterned retardation film from which a large number of patterned retardation films can be produced. Furthermore, the long form makes it possible to make the flexibility of the production process high.

In the invention, it is preferred that the first alignment region and the second alignment region are formed into a pattern in the form of bands parallel to each other in the longitudinal direction of the alignment film.

This matter makes it easy to cause the pattern in which the first and second retardation regions are formed to have a relationship corresponding to a pattern in which pixels are formed in a color filter or some other used in a display device. This also makes it possible to produce a large number of patterned retardation films easily by the following: preparing the long alignment layer wound into a roll form; feeding the long alignment film while the long alignment layer wound in the roll form is unwound; and then feeding the film continuously while the film is irradiated with polarized ultraviolet rays.

In the invention, it is preferred that the respective directions along which the rodlike compound is caused to be arranged in the first alignment region and the second alignment region are different from each other by 90°. When a retardation layer is formed on this patterned alignment film, the first retardation region and the second retardation region contained in the retardation layer can be caused to have a relationship that their directions each giving the largest refractive index (slow axis directions) are orthogonal to each other. Thus, the long patterned alignment film of the invention can be more favorably used to produce 3D display devices.

In the invention, it is preferred that: the respective directions along which the rodlike compound is caused to be arranged in the first alignment region and the second alignment region are a direction having an angle of 0° to the longitudinal direction and a direction having an angle of 90° to the longitudinal direction, respectively; or the respective directions along which the rodlike compound is caused to be arranged in the first alignment region and the second alignment region are a direction having an angle of 45° to the longitudinal direction and a direction having an angle of 135° to the longitudinal direction, respectively.

When the rodlike compound has the former arranging direction, the long patterned alignment film of the invention can be rendered a film usable suitably for, for example, 3D liquid crystal display devices in a TN mode.

When the rodlike compound has the latter arranging direction, the long patterned alignment film of the invention can be rendered a film usable suitably for, for example, 3D liquid crystal display devices in a VA or IPS mode.

In the invention, it is preferred that a transparent film substrate is formed on the alignment layer. This matter makes it possible to make the formation of the alignment layer easy.

In the invention, it is preferred that an antireflective layer and/or an antiglare layer is/are formed on a surface of the transparent film substrate that is opposite to the surface on which the alignment layer is formed. When a display device is produced, this matter makes it possible to form a patterned retardation film capable of giving a display device good in display quality.

The invention provides a long patterned retardation film comprising the above-mentioned long patterned alignment film, and a retardation layer formed on the alignment layer of the long patterned alignment film and comprising a rodlike compound having a refractive index anisotropy.

According to the invention, the long patterned retardation film has the above-mentioned long patterned alignment film, and this matter makes it possible to render this long patterned retardation film a film having a first retardation region and a second retardation region in which the respective arranging directions of the rodlike compound are different from each other.

It is therefore possible to form easily a large number of patterned retardation films applicable to three-dimensional display devices.

Moreover, the long patterned retardation film is long, and thus the production process of the patterned retardation film can be made high in flexibility.

In the invention, it is preferred that the in-plane retardation value of the retardation layer corresponds to λ/4. This matter makes it possible to convert respective linearly polarized light rays passing through the first and second retardation regions to circularly polarized light rays orthogonal to each other. Thus, when the in-plane retardation value of the retardation layer corresponds to λ/4, the long patterned retardation film of the invention can be rendered a film usable more suitably for producing 3D display devices.

In the invention, it is preferred that an adhesive layer and a separator are, in this order, formed on the retardation layer. This matter makes it possible to bond the long patterned retardation film of the invention easily onto a different member.

### Advantageous Effects of Invention

The long patterned alignment film of the invention produces an advantageous effect of making it possible to produce a large number of patterned retardation films easily.

### BRIEF DESCRIPTION OF DRAWINGS

FIG. 1 is a sectional view taken on line A-A in FIG. 2.

FIG. 2 is a schematic plan view illustrating an example of the long patterned alignment film of the present invention.

FIG. 3 is a schematic plan view illustrating another example of the long patterned alignment film of the invention.

FIG. 4 is a schematic sectional view illustrating still another example of the long patterned alignment film of the invention.

FIGS. 5A to 5D are a process chart illustrating an example of a method for producing the long patterned alignment film of the invention.

FIG. 6 is a schematic view illustrating an example of an apparatus for producing the long patterned alignment film of the invention.

FIG. 7 is a schematic view illustrating another example of the apparatus for producing the long patterned alignment film of the invention.

FIGS. 8A to 8C are explanatory views for describing an exposing step used in the invention.

FIGS. 9A to 9C are explanatory views for describing the exposing step used in the invention.

FIG. 10 is an explanatory view for describing the exposing step used in the invention.

FIG. 11 is an explanatory view for describing the exposing step used in the invention.

FIGS. 12A to 12D are explanatory views for describing the exposing step used in the invention.

FIG. 13 is a sectional view taken on line B-B in FIG. 15.

FIG. 14 is a perspective view taken on line B-B in FIG. 15.

FIG. 15 is a schematic plan view illustrating an example of the long patterned retardation film of the invention.

FIG. 16 is a schematic sectional view illustrating another example of the long patterned retardation film of the invention.

FIG. 17 is a schematic view illustrating an example of an apparatus for producing the long patterned retardation film of the invention.

FIG. 18 is a schematic view illustrating another example of the apparatus for producing the long patterned retardation film of the invention.

FIG. 19 is a schematic view illustrating an example of a liquid crystal display device capable of displaying a three-dimensional image in a passive mode.

### DESCRIPTION OF EMBODIMENTS

The present invention relates to a long patterned alignment film, and a long patterned retardation film using the long patterned alignment film.

Hereinafter, a detailed description will be made about the long patterned alignment film of the invention, and the long patterned retardation film thereof.

A. Long Patterned Alignment Film

The long patterned alignment film of the invention is initially described.

The long patterned alignment film of the invention comprises an alignment layer which is in a long form and comprising an optical alignment material, wherein the alignment layer comprises a first alignment region for causing a rodlike compound having a refractive index anisotropy to be arranged in a certain direction, and a second alignment region for causing the rodlike compound to be arranged in a direction different from the certain direction of the first alignment region.

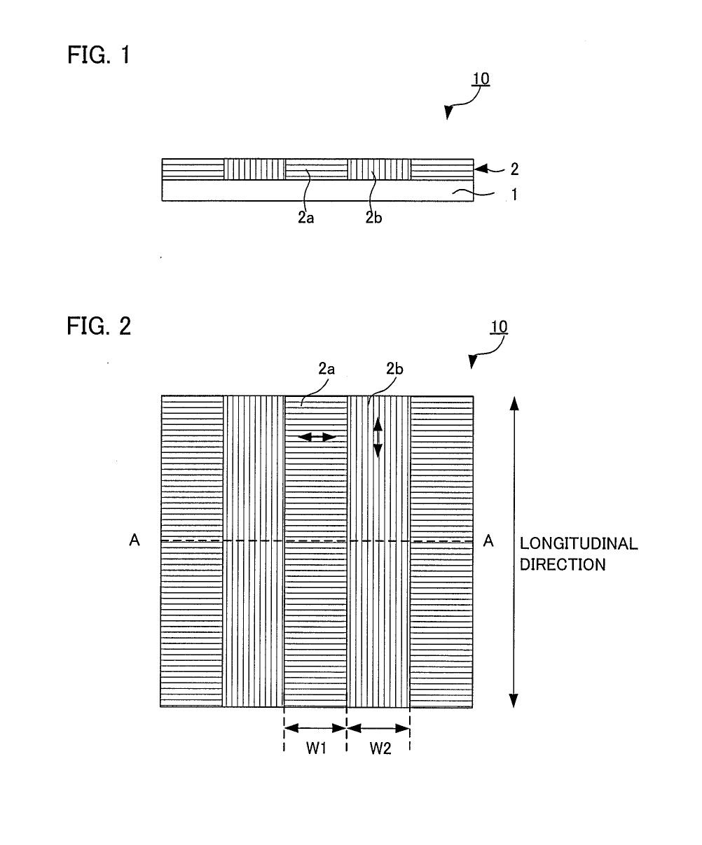

Referring to the drawings, the long patterned alignment film of the invention is described. FIG. 1 is a sectional view taken on line A-A in FIG. 2. FIG. 2 is a schematic plan view illustrating an example of the long patterned alignment film of the invention. As illustrated in FIGS. 1 and 2, a long patterned alignment film 10 of the invention comprises a long transparent film substrate 1 and a long alignment layer 2 formed on the transparent film substrate 1 and containing an optical alignment material. The alignment layer 2 is a layer having first alignment regions 2a for causing a rodlike compound as defined above to be arranged in a certain direction, and second alignment regions 2b for causing the rodlike compound to be arranged in a direction different from the certain direction of the first alignment region 2a.

Incidentally, in this example, the first alignment region is a region having an alignment regulating force for arranging the rodlike compound in a direction orthogonal to the long direction (longitudinal direction) of the film while the second alignment region is a region having an alignment regulating force for arranging the rodlike compound in a direction parallel to the long direction (longitudinal direction). The first alignment regions 2a and the second alignment regions 2b are formed in the form of bands which are parallel to the long direction (longitudinal direction) and have a width of W1 and a width of W2, respectively.

Incidentally, the word “long” or the wording “long form” denotes, out of shapes each geometrically identical to or approximately to a rectangular parallelepiped, in particular, any shape formed to have a length sufficiently larger than the width and the thickness thereof and further make the thickness sufficiently smaller than the length and the width. The word or wording denotes, for example, the form of a band having such a length that the band-form article can be wound into a roll form. The length of the long patterned retardation film may be decided at will in accordance with factors such as a weight thereof permitted to be set into an apparatus for the production, and others. Specifically, the length is preferably 10 m or more, more preferably from 50 m to 5000 m, and in particular preferably from 100 m to 4000 m.

The length is preferably 10 or more times the width, more preferably from 50 to 5000 times the width, in particular preferably from 100 to 4000 times the width. The thickness is preferably from 1/1000 to 1/1000000 of the width. Specifically, about the alignment layer, the thickness is preferably from 0.01 μm to 1.0 μm; about the retardation layer, the thickness is preferably from 0.5 μm to 2 μm; and about the transparent film substrate, the thickness is preferably from 10 μm to 1000 μm. The ranges make these members excellent in handleability and others.

According to the invention, the long patterned alignment film has the first and second alignment regions, and this matter makes it possible that by action of applying the rodlike compound thereto, a retardation layer is easily formed which has a first retardation region and a second retardation region in which the respective arranging directions of the rodlike compound are different from each other.

Moreover, the patterned alignment film is in a long form, thereby making it possible that by action of applying the rodlike compound continuously thereto, a long patterned retardation film is easily formed from which a large number of patterned retardation films can be produced. Furthermore, the long form makes it possible to make the flexibility of the production process of the long patterned retardation film high. Thus, for example, the long patterned alignment film can be stored in a roll form, or the long patterned retardation film be formed through the step of unwinding the long patterned alignment film from the state that the film is stored in the roll form.

The long patterned alignment film of the invention has at least an alignment layer.

Hereinafter, constituents of the long patterned alignment film of the invention will each be described in detail.

1. Alignment Layer

The alignment layer used in the invention is in a long form and contains an optical alignment material.

The alignment layer has a function that when a retardation layer is formed thereon, its rodlike compound is caused to be arranged. In the alignment layer used in the invention, the first and second alignment regions detailed above are patternwise formed on the surface of the alignment layer. Thus, in accordance with the pattern, the first and second retardation regions detailed above are patternwise arranged on the retardation layer.

(1) First and Second Alignment Regions

The first and second alignment regions formed in the alignment layer in the invention are each a region having a function of causing a rodlike compound contained in a retardation layer to be arranged into one direction. The respective directions along which the rodlike compound is caused to be arranged are different from each other. In the invention, the first and second alignment regions are patternwise formed.

In the alignment layer in the invention, the pattern in which the first and second alignment regions are formed may be appropriately decided in accordance with a use purpose of the long patterned alignment film of the invention, and other factors. Thus, the pattern is not particularly limited. Examples of this pattern include a band-form pattern, a mosaic-form pattern, and a staggered arrangement pattern. It is particularly preferred in the invention that the first and second alignment regions are formed into a pattern in the form of bands parallel to each other. When the first and second alignment regions are formed in this pattern, the following is made easy: in the case of using, for example, a patterned retardation film formed by use of the long patterned alignment film of the invention to produce a liquid crystal display device, the pattern in which the first and second alignment regions are formed is caused to have a relationship corresponding to a pattern in which pixels are formed in a color filter used in the liquid crystal display device. For this reason, by the matter that the first and second alignment regions are formed in the pattern in the form of the bands parallel to each other, a 3D liquid crystal display device can easily be produced, using the long patterned alignment film of the invention. In other words, the long patterned alignment film of the invention can be used suitably for a 3D liquid crystal display device.

Moreover, the matter that the first and second alignment regions are formed in the pattern in the form of the bands parallel to each other makes the following easy: in the case of using the long patterned alignment film of the invention to produce a light emitting type display device such as a plasma display, an organic EL or an FED, the pattern in which the first and second alignment regions are formed is caused to have a relationship corresponding, through a polarizing plate, to a pattern in which pixel regions are formed in a light emitting type display in the light emitting type display device. For this reason, by the matter that the first and second alignment regions are formed in the pattern in the form of the bands parallel to each other, a 3D light emitting type display device can easily be produced, using the long patterned alignment film of the invention. In other words, the long patterned alignment film of the invention can be used suitably for a 3D light emitting type display device. Incidentally, if necessary, a color filter may be used in the light emitting type display device.

In the case where the first and second alignment regions are formed in the pattern in the form of the bands parallel to each other, specific examples of the case include the above-mentioned long patterned alignment film illustrated in FIGS. 1 and 2.

When the first and second alignment regions are formed in a pattern in the form of bands, the respective widths of the first and second alignment regions may be equal to or different from each other. However, it is preferred in the invention that the respective widths of the first and second alignment regions are equal to each other. In a color filter used in a liquid crystal display device, pixel regions including R, G, B and some other are usually formed to be equal to each other in width. Thus, by making the respective widths of the above-mentioned first and second alignment regions equal to each other, the following is made easy: when the long patterned alignment film of the invention is used to produce a liquid crystal display device capable of attaining three-dimensional displays, the pattern in which the first and second alignment regions are formed is caused to have a relationship corresponding to a pattern in which pixel regions are formed in a color filter used in the liquid crystal display device. As a result, a 3D display device can easily be produced by use of the long patterned alignment film of the invention. Moreover, pixel regions used in a light emitting type display device are also formed to be equal to each other in width. Thus, by making the respective widths of the above-mentioned first and second alignment regions equal to each other, the following is made easy: when the long patterned alignment film of the invention is used to produce a light emitting type display device capable of attaining three-dimensional displays, the pattern in which the first and second alignment regions are formed is caused to have a relationship corresponding to a pattern in which pixel regions used in the light emitting type display device are formed. As a result, a 3D light emitting type liquid crystal display device can easily be produced by use of the long patterned alignment film of the invention. When the pattern in which the first and second alignment regions are formed is positioned to be precisely fitted to a stripe pattern of the color filter, it is preferred to form the former pattern and the latter stripe pattern of the color filter to have widths having a relationship corresponding to each other.

Specific values of the respective widths of the first and second alignment regions are appropriately decided in accordance with a use purpose of the long patterned alignment film of the invention. When the long patterned alignment film of the invention is used to produce, for example, a liquid crystal display device capable of attaining three-dimensional displays, the respective widths of the first and second alignment regions are appropriately decided to correspond to the width of pixel regions formed in a color filter used in the liquid crystal display device. As described herein, the respective widths of the first and second alignment regions are not particularly limited. Usually, the widths are each preferably from 50 μm to 1000 μm, and more preferably from 100 μm to 600 μm.

When the first and second alignment regions are formed in the pattern in the above-mentioned band form in the invention, a black line which absorbs light may be laid between the first and second alignment regions. In this case, the width of the black line is not particularly limited. Usually, the width is preferably from 10 μm to 30 μm.

The region where this black line is formed may be a region having alignment regulating force, or a region having no alignment regulating force.

When the first and second alignment regions are formed in the pattern in the band form in the invention, the respective directions of the bands in the pattern are not particularly limited. The directions of the bands may be, for example, directions parallel to the longitudinal direction (long direction) of the long patterned alignment film of the invention, directions orthogonal thereto, or directions crossing the longitudinal direction obliquely. In the invention, it is preferred in the invention that the respective directions of the bands in the pattern are directions parallel to the longitudinal direction of the long patterned alignment film, in other words, the first and second alignment regions are formed in a pattern of the form of bands parallel to the longitudinal direction.

This matter makes it easy to cause the pattern in which the first and second retardation regions are formed to have a relationship corresponding to a pattern in which pixels are formed in a color filter or some other used in a display device. Moreover, the matter makes it possible to form a large number of long patterned retardation films easily by preparing the long alignment layer into a wound roll form, and unwinding this roll-form long alignment layer and simultaneously irradiating the alignment layer with polarized ultraviolet rays while the alignment layer is continuously fed.

The respective alignment regulating forces, that is, directions along which the rodlike compound is caused to be arranged, which the first and second alignment regions have in the invention, are not particularly limited as far as the forces or directions are different from each other. The directions are different from each other preferably by 90°. This case makes it possible to form the first and second alignment regions to have alignment regulating forces for making directions along which the rodlike compound is caused to be arranged orthogonal to each other, that is, to make directions of the first and second retardation regions along each of which the refractive index is the largest (slow axis directions) orthogonal to each other. Consequently, the long patterned alignment film of the invention can be rendered a film usable more suitably for producing a display device capable of attaining three-dimensional displays.

Incidentally, the directions different from each other by 90° are not particularly limited as far as the directions make it possible that when the long patterned alignment film of the invention is used to form a display device capable of attaining three-dimensional displays, the three-dimensional displays are precisely achieved. Usually, the angle between the directions is preferably within about 90°±3°, more preferably within about 90°±2°, and even more preferably within about 90°±1°. This angle makes it possible to produce a display device capable of attaining high-performance three-dimensional displays.

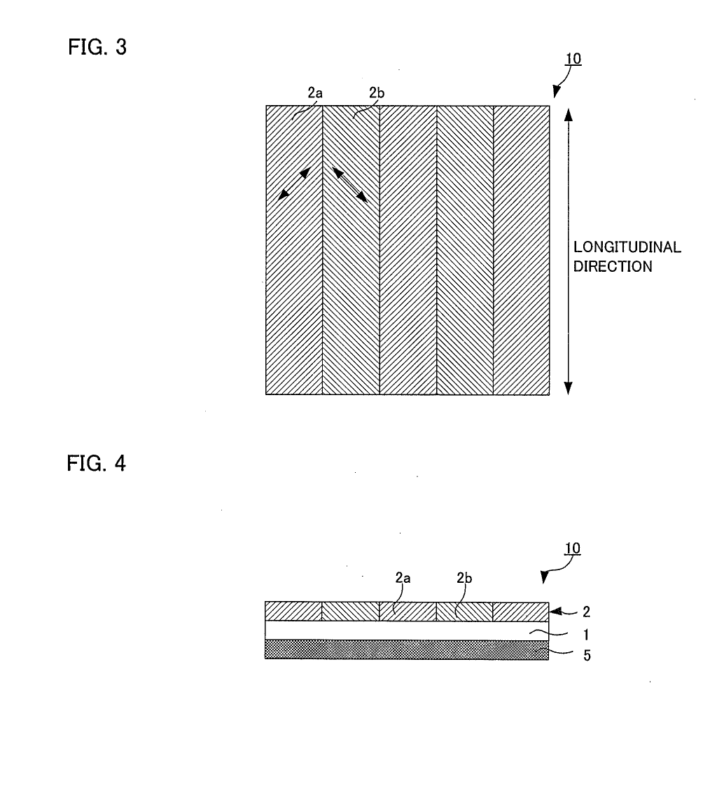

Specific examples of the first and second regions in which the directions along which the rodlike compound is caused to be arranged are different by 90° are preferably directions having angles of 90° (the first alignment regions 2a) and 0° (the second alignment regions 2b) to the longitudinal direction of the long patterned alignment film as has already been illustrated in FIG. 2; and directions having angles of 45° (the first alignment regions 2a) and 135° (the second alignment regions 2b) to the longitudinal direction, as illustrated in FIG. 3. In the case of the directions having the angles of 90° and 0°, respectively, the long patterned alignment film of the invention can be rendered a film usable suitably for, for example, three-dimensional liquid crystal display devices in a TN mode. In the case of the directions having the angles of 45° and 135°, respectively, the long patterned alignment film of the invention can be rendered a film usable suitably for, for example, three-dimensional liquid crystal display devices in a VA or IPS mode.

Reference signs in FIG. 3 represent the same members as in FIG. 2, respectively. Thus, any description thereabout is omitted herein. The direction of arrows in each of the alignment regions is a direction along which the rodlike compound is caused to be arranged in the region.

(2) Optical Alignment Material

The optical alignment material used in the invention is a material which can exhibit alignment regulating force by irradiation with polarized ultraviolet rays. The wording “alignment regulating force” denotes an interaction for arranging the rodlike compound, which will be detailed later.

This optical alignment material is not particularly limited as far as the material is a material which exhibits the alignment regulating force by irradiation with polarized light. The optical alignment material can be roughly classified into optical isomerization material, in which only the molecular form thereof is changed through cis-trans change to vary the alignment regulating force reversely, and optical reaction material, in which the molecule thereof itself is changed by irradiation with polarized light. In the invention, either one of the optical isomerization material and the optical reaction material is favorably usable. It is preferred to use the optical reaction material. As described above, about the optical reaction material, the molecule reacts by irradiation with polarized light so that the material exhibits the alignment regulating force; consequently, the alignment regulating force can be irreversibly exhibited. Thus, the optical reaction material shows, over time, a higher stability in the alignment regulating force.

The optical reaction material can be further classified in accordance with the type of the reaction caused by the irradiation with polarized light. Specifically, the material can be classified into photo-dimerization type material, in which photo-dimerization reaction is caused to exhibit the alignment regulating force; photo decomposition type material, in which photo decomposition reaction is caused to exhibit the alignment regulating force; photo coupling type material, in which photo coupling reaction is caused to exhibit the alignment regulating force; photo decomposition-coupling type compound, in which photo decomposition-coupling reaction is caused to exhibit the alignment regulating force; and others. In the invention, any one of these optical reaction materials is favorably usable. It is more preferred from the viewpoint of stability, reactivity (sensitivity) and others to use, among these materials, photo-dimerization type material.

The photo-dimerization type material used in the invention is not particularly limited as far as the material is a material which is to undergo photo-dimerization reaction to make it possible to exhibit alignment regulating force. In the invention, the wavelength of light for generating the photo-dimerization reaction is preferably 280 nm or more, in particular preferably from 280 nm to 400 nm, and more preferably from 300 nm to 380 nm.

The photo-dimerization type material is, for example, a polymer having a cinnamate, coumarin, benzylidenephthalimidine, benzylideneacetophenone, diphenylacetylene, stilbazole, uracil, quinolinone, maleinimide, or a cinnamylidene acetic acid derivative. Preferred are a polymer having at least one of a cinnamate and coumarin, and a polymer having a cinnamate and coumarin. Specific examples of the photo-dimerization type material include compounds described in JP-A No. H09-118717, JP-A (Japanese Translation of PCT Application) No. H10-506420, JP-A (Japanese Translation of PCT Application) No. 2003-505561, WO 2010/150748, WO 2011/126019, WO 2011/126021, and WO 2011/126022.

The cinnamate and coumarin in the invention are preferably compounds each represented by the following formula Ia or Ib:

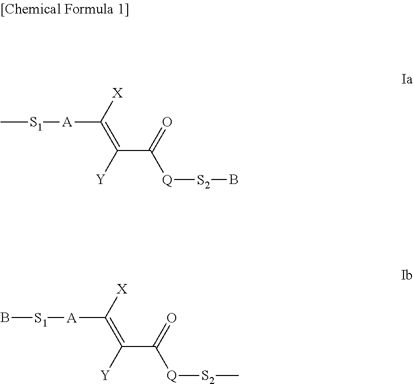

In the formula, A represents pyrimidine-2,5-diyl, pyridine-2,5-diyl, 2,5-thiophenylene, 2,5-furanylene or 1,4- or 2,6-naphthylene, or represents a phenylene unsubstituted or mono- or multi-substituted with one or more selected from fluorine atoms, chlorine atoms, and cyclic, linear or branched alkyl residues each having 1 to 18 carbon atoms (the residues being each unsubstituted or mono- or multi-substituted with one or more selected from fluorine atoms and chlorine atoms, and being each a residue in which one or more —CH₂— groups not adjacent to each other may be each independently substituted with a group C or groups Cs).

In the formula, B represents a hydrogen atom, or represents a group which can react or interact with a second substance, such as a polymer, oligomer, monomer, optically active polymer, optically active oligomer and/or optically active monomer, or the surface.

In the formula, C represents a group selected from —O—, —CO—, —CO—O—, —O—CO—, —NR₁—, —NR₁—CO—, —CO—NR₁—, —NR₁—CO—O—, —O—CO—NR₁—, —NR₁—CO—NR₁—, —CH═CH—, —C≡C—, —O—CO—O—, and —Si(CH₃)₂—O—Si(CH₃)₂— in which R₁s each represent a hydrogen atom or a lower alkyl.

In the formula, D represents a group selected from —O—, —CO—, —CO—O—, —O—CO—, —NR₁—, —NR₁—CO—, —CO—NR₁—, —NR₁—CO—O—, —O—CO—NR₁—, —NR₁—CO—NR₁—, —CH═CH—, —C≡C—, —O—CO—O—, and —Si(CH₃)₂—O—Si(CH₃)₂— in which R₁s each represent a hydrogen atom or a lower alkyl; an aromatic group; or an alicyclic group.

In the formula, S₁ and S₂ each independently represent a single bond, or a spacer unit, for example, a linear or branched alkylene group having 1 to 40 carbon atoms (the group being unsubstituted or mono- or multi-substituted with one or more selected from fluorine atoms and chlorine atoms, and being a group in which one or more —CH₂— groups not adjacent to each other may be each independently substituted with a group D or groups Ds provided that oxygen atoms therein are not bonded directly to each other).

In the formula, Q represents an oxygen atom or —NR₁— in which R₁ represents a hydrogen atom or a lower alkyl.

In the formula, X and Y each independently represent hydrogen, fluorine, chlorine, cyano, or an alkyl group having 1 to 12 carbon atoms (the group being substituted with fluorine as the case may be, and being a group in which one or more —CH₂— groups not adjacent to each other are substituted with —O—, —CO—O—, —O—CO— and/or —CH═CH— as the case may be.

As such a photo-dimerization type material, a commercially available product is usable, a specific example thereof being ROP-103 (trade name) from Rolic Technologies Ltd., according to WO 08/031,243 and WO 08/130,555.

The optical alignment material used in the invention may be a material having refractive index anisotropy. When this optical alignment material is used, the patterned alignment film produced by the producing method of the invention is usable as a patterned retardation film.

Incidentally, the optical alignment material having refractive index anisotropy may be specifically any optical alignment material described in JP-A No. 2002-082224.

About the optical alignment material used in the invention, only one species thereof may be used, or two or more species thereof may be used.

(3) Alignment Layer

The alignment layer used in the invention is a layer containing at least an optical alignment material. The layer may contain a different compound if necessary.

The different compound is not particularly limited as far as the compound does not damage the alignment regulating force of the alignment layer in the invention. In the invention, the different compound is preferably a monomer or oligomer having one or more functional groups. When the alignment layer contains the monomer or oligomer, the alignment layer can be rendered a layer excellent in adhesiveness onto a retardation layer formed onto the alignment layer and containing a rodlike compound having refractive index anisotropy.

Examples of the monomer or oligomer used in the invention include monofunctional monomers each having an acrylate type functional group (such as reactive ethyl (meth)acrylate, ethylhexyl (meth)acrylate, styrene, methylstyrene, and N-vinyl pyrrolidone); polyfunctional monomers (such as polymethylolpropane tri(meth)acrylate, hexanediol (meth)acrylate, triethylene(polypropylene) glycol diacrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, neopentyl glycol di(meth)acrylate, and isocyanuric acid poly(meth)acrylates (such as isocyanuric acid EO diacrylate)); and bisphenol fluorene derivatives (such as bisphenoxyethanol fluorene di(meth)acrylate, and bisphenol fluorene diepoxy (meth)acrylate). These may be used alone or in the form of a mixture.

It is preferred to use, as the monomer or oligomer, a compound in a solid form at room temperature (20 to 25° C.) This case makes it possible that even when a long-alignment-film-forming film in which an alignment-layer-forming layer is laminated on a transparent film substrate is stored in the state of being wound into a roll form, the generation of blocking is prevented which results from a matter that the alignment-layer-forming layer bonds to the rear surface of the transparent substrate.

The content of the monomer or oligomer in the invention is not particularly limited as far as the content does not cause the alignment regulating force of the alignment layer to be damaged and causes the alignment layer to exhibit a desired adhesiveness and others. The content is preferably from 0.01 to 3 times the mass of the optical alignment material, and in particular preferably from 0.05 to 1.5 times the mass.

The thickness of the alignment layer in the invention is not particularly limited as far as the alignment layer can exhibit a desired alignment regulating force to the rodlike compound having refractive index anisotropy, the compound being to be detailed later. Usually, the thickness is preferably from 0.01 μm to 1.0 μm, more preferably from 0.03 μm to 0.5 μm, and in particular preferably from 0.05 μm to 0.20 μm.

2. Long Patterned Alignment Film

The long patterned alignment film of the invention is a film comprising at least an alignment layer. Usually, the long patterned alignment film has a transparent film substrate formed on the alignment layer. This case makes it possible to form the alignment layer in a long form easily by preparing the transparent film substrate into a long form, and then applying, onto this long transparent film substrate, an alignment-layer-forming coating solution containing an optical alignment material as described above.

In the invention, the long patterned alignment film may have a different constituent if necessary. An example of the different constituent is an antiglare layer or antireflective layer 5 as illustrated in FIG. 4, which is formed on a surface of the transparent film substrate 1 that is opposite to the surface thereof on which the alignment layer 2 is formed. This case makes it possible to form, when a display device is produced, a patterned retardation film capable of making the produced display device good in display quality.

Incidentally, reference signs in FIG. 4 represent the same members as in FIG. 1, respectively. Thus, description thereabout is omitted herein.

(1) Transparent Film Substrate

The transparent film substrate used in the invention is a substrate having a function of supporting the alignment layer and/or others, and formed into a long form.

The transparent film substrate used in the invention is preferably a substrate low in retardation. More specifically, about the transparent film substrate used in the invention, the in-plane retardation value (Re value) is preferably from 0 nm to 10 nm, more preferably from 0 nm to 5 nm, and even more preferably from 0 nm to 3 nm. If the in-plane retardation value of the transparent film substrate is larger than the range, a display device formed by use of the long patterned alignment film of the invention so as to be capable of displaying three-dimensional pictures may become bad in display quality.

About the transparent film substrate used in the invention, the transmittance in the visible light band is preferably 80% or more, and more preferably 90% or more. The transmittance of any transparent film substrate is measurable according to JIS K7361-1 (Method for Testing Total Light Transmittance of Plastic Transparent Material).

The transparent film substrate used in the invention is preferably a flexible material having such a flexibility that the substrate can be wound into a roll form.

Examples of the flexible material include cellulose derivatives, norbornene based polymers, cycloolefin based polymers, polymethyl methacrylate, polyvinyl alcohol, polyimide, polyarylate, polyethylene terephthalate, polysulfone, polyethersulfone, amorphous polyolefin, denatured acyclic polymer, polystyrene, an epoxy resin, polycarbonate, and polyester. It is preferred to use, among these examples, cellulose derivatives. The cellulose derivatives are particularly good in optical isotropy; thus, in the case of using the long patterned alignment film of the invention to form a patterned retardation film, the film can be made excellent in optical properties.

It is preferred in the invention to use, among the cellulose derivatives, cellulose esters. It is more preferred to use, among the cellulose esters, any cellulose acylate. Since the cellulose acylate is industrially widely used, the acylate is favorable in availability.

The cellulose acylate is preferably a lower aliphatic acid ester having 2 to 4 carbon atoms. The lower aliphatic acid ester may be a compound containing only a single lower aliphatic acid ester, such as cellulose acetate, or may be a compound containing multiple aliphatic acid esters, such as cellulose acetate butyrate, or cellulose acetate propionate.

It is particularly preferred in the invention to use, among species of the lower aliphatic acid ester, cellulose acetate. The most preferably usable species of cellulose acetate is a triactylcellulose having an average acetylation degree of 57.5 to 62.5% (substitution degree: 2.6 to 3.0). The acetylation degree means the quantity of bonded acetic acid per cellulose-unit-mass. The acetylation degree can be obtained by measurement and calculation of the degree of acetylation according to ASTM: D-817-91 (Method for Testing Cellulose Acetate and Others). Incidentally, the acetylation degree of a triacetylcellulose constituting a triacetylcellulose film can be obtained by this method after a plasticizer and other impurities contained in the film are removed.

The thickness of the transparent film substrate used in the invention is not particularly limited as far as the thickness can give the long patterned alignment film of the invention self-supporting property necessary for the film in accordance with a use purpose of the long patterned alignment film, and others. Usually, the thickness is preferably from 25 μm to 125 μm, more preferably from 40 μm to 100 μm, and in particular preferably 60 μm to 80 μm. If the thickness of the transparent film substrate is smaller than the range, the self-supporting property necessary for the long patterned alignment film of the invention may not be given to the film. If the thickness is larger than the range, for example, the following may be caused at the time of cutting the long patterned alignment film of the invention to be turned into patterned retardation films in a sheet-like form: wastes from the cutting are increased, or the cutting blade is rapidly worn away.

The structure of the transparent film substrate used in the invention is not limited to a structure made of a single layer. Thus, the structure may be a structure in which multiple layers are laminated onto each other. When the transparent film substrate has the latter structure, in which multiple layers are laminated onto each other, these laminated layers may be layers identical to each other in composition, or layers different from each other in composition.

The transparent film substrate used in the invention is made in a long form, and the length and other factors thereof may be equivalent to those of the above-mentioned alignment layer.

(2) Antiglare Layer and Antireflective Layer

When an antireflective layer as described above is formed in the invention, the advantage is produced that when the long patterned alignment film of the invention is used to produce a liquid crystal display device, the produced liquid crystal display device can give a good display quality. Either one of the antiglare layer and the antireflective layer may be used, or both thereof may be used.

The antiglare layer is a layer having a function of decreasing a projection of external light from the sun, a fluorescent lamp or some other onto the display screen of the display device, this projection being generated by a matter that the external light is radiated onto the screen and then reflected thereon. The antireflective layer is a layer having a function of restraining the regular reflectivity on the front surface to make the contrast of any image thereon good, thereby improving the visibility of the image. The antiglare layer or the antireflective layer used in the invention is not particularly limited as far as the layer has a desired antiglare function or antireflective function. The layer may be an antiglare layer or antireflective layer known generally as such a layer as used in a display device for improving the display quality thereof. The antiglare layer may be, for example, a resin layer in which fine particles are dispersed, and the antireflective layer may be, for example, a layer having a structure in which layers having different refractive indexes are laminated onto each other.

Incidentally, when the antireflective layer is laid onto the outermost surface of the antiglare layer, the image visibility in a bright room can be further improved.

3. Method for Producing Long Patterned Alignment Film

The method for producing any long patterned alignment film of the invention is not particularly limited as far as the method is a method capable of producing, with stability, the long patterned alignment film, which comprises at least the alignment layer detailed above. The method may be an ordinary alignment-layer-producing method.

In the invention, the method is preferably a method having: a preparing step of applying, onto a long transparent film substrate, an alignment-layer-forming coating solution containing an optical alignment material to form a long-alignment-film-forming film having a non-aligned alignment-layer-forming layer; and an exposing step involving a first exposing processing of feeding the long-alignment-film-forming film continuously, and simultaneously irradiating the alignment-layer-forming layer with polarized ultraviolet rays, and a second exposing processing of irradiating the resultant with polarized ultraviolet rays different in polarization direction from those radiated in the first exposing processing, in which in at least one of the first and second exposing processing, the polarized ultraviolet rays are patternwise radiated onto the alignment-layer-forming layer. This method makes it possible to form a long patterned alignment film easily and continuously.

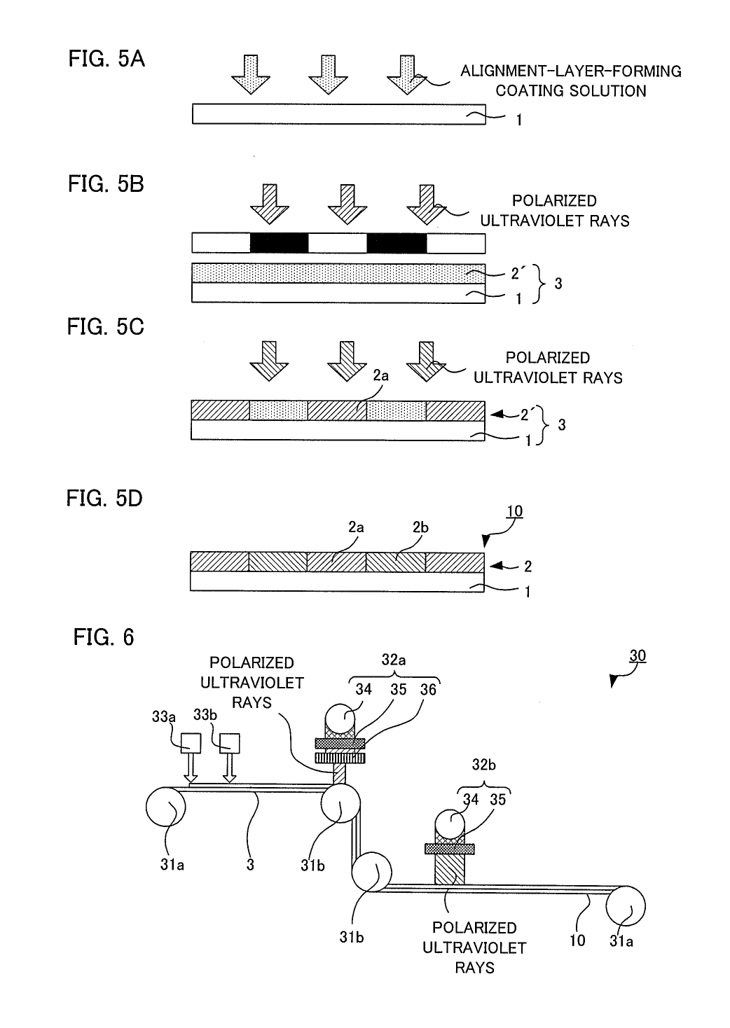

Referring to some of the drawings, a description will be made about the method for producing a long patterned alignment film of the invention. FIGS. 5A to 5D are a process chart illustrating an example of this method, which is for producing a long patterned alignment film of the invention. As illustrated in FIGS. 5A to 5D, an alignment-layer-forming coating solution is initially applied onto a transparent film substrate 1 (FIG. 5A) to form a long-alignment-film-forming film 3 having the transparent film substrate 1 and an alignment-layer-forming layer 2′ formed on the transparent film substrate 1 and containing an optical alignment material. While this long-alignment-film-forming film 3 is continuously fed, polarized ultraviolet rays are patternwise radiated through a mask onto the alignment-layer-forming layer 2′ (FIG. 5B) to form first alignment regions 2a. Next, polarized ultraviolet rays different from the ultraviolet rays used when the first alignment regions 2a are formed are radiated onto the entire front surface (FIG. 5C) to form second alignment regions 2b different from the first alignment regions 2a in a direction along which the rodlike compound is caused to be arranged. In this way, a long patterned alignment film 10 is yielded (FIG. 5D).

In this example, FIG. 5A illustrates the preparing step. FIGS. 5B to C illustrate the exposing step. FIG. 5B illustrates the first exposing processing; and FIG. 5C the second exposing processing.

Referring to some of the drawings, a description will be made about a long-patterned-alignment-film producing apparatus used to form such a long patterned alignment film.

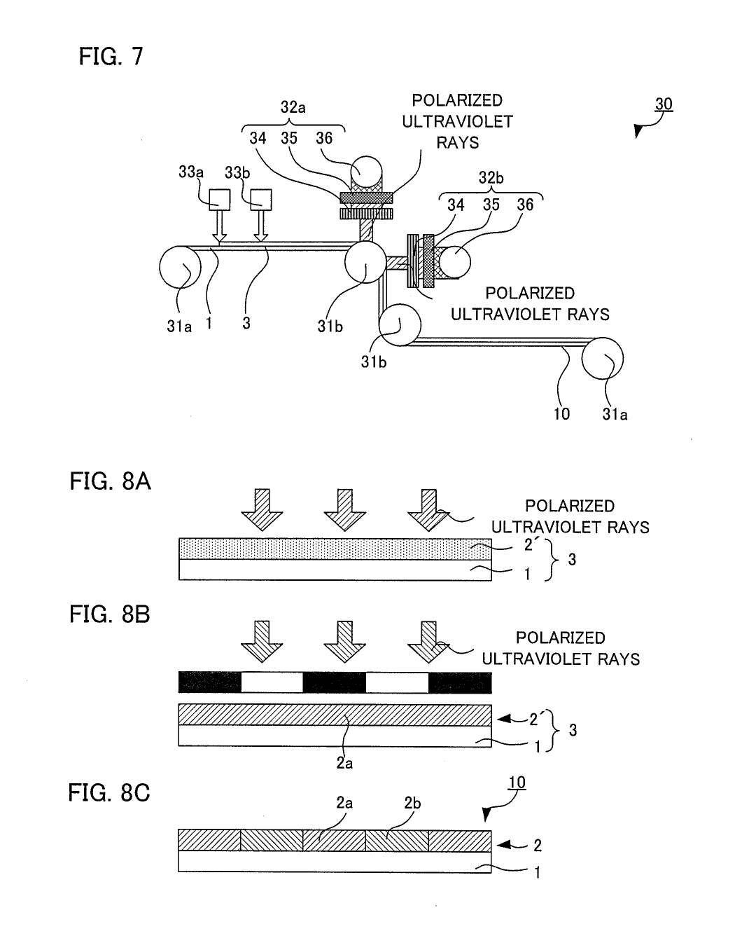

FIGS. 6 and 7 are each a schematic view illustrating an example of the long-patterned-alignment-film producing apparatus. As illustrated in each of FIGS. 6 and 7, a long-patterned-alignment-film producing apparatus 30 has a feeding unit containing a winding/unwinding unit 31a and a feeding roll 31b for feeding the transparent film substrate 1 continuously, and an exposing unit having a first exposing part 32a and a second exposing part 32b for radiating polarized ultraviolet rays onto the alignment-layer-forming layer of the above-mentioned long-alignment-film-forming film 3, which is being continuously fed. The apparatus also has, on the transparent film substrate 1, an applicator 33a for applying an alignment-layer-forming coating solution to form an alignment-layer-forming layer, and a drying device 33b for drying the coated film.

In FIG. 6, the first exposing part 32a includes a light source 34 for radiating ultraviolet rays orthogonally onto the alignment-layer-forming layer, a polarizer 35, and a mask 36 having openings in a pattern form. This part is a part for radiating the ultraviolet rays patternwise onto the long-alignment-film-forming film 3 on the feeding roll. The second exposing part 32b has a polarizer 35 different in polarization axis direction from the first exposing part.

In FIG. 7, both of the first exposing part 32a and the second exposing part 32b have the mask 36 and another mask 36, and are each a part for radiating polarized ultraviolet rays patternwise onto the alignment-layer-forming layer on the feeding roll 31b.

(1) Preparing Step

The preparing step in the invention is a step of forming a long-alignment-film-forming film having a transparent film substrate, and an alignment-layer-forming layer formed on the transparent film substrate and containing an optical alignment material.

In the step, the method for forming the alignment-layer-forming layer containing the optical alignment material is not particularly limited as far as the method is a method capable of forming the alignment-layer-forming layer containing the optical alignment material into a desired thickness. An example thereof is a method of applying, onto the transparent film substrate, the alignment-layer-forming layer containing the optical alignment material.

The content by percentage of the optical alignment material in the alignment-layer-forming coating solution is not particularly limited as far as the content is within a range capable of preparing the alignment-layer-forming coating solution to have a desired viscosity in accordance with the applying method and others. In the step, the content by percentage of the optical alignment material in the alignment-layer-forming coating solution is preferably from 0.5% by mass to 50% by mass, more preferably from 1% by mass to 30% by mass, and even more preferably from 2% by mass to 20% by mass. If the content by percentage of the optical alignment material is larger than the range, it may be difficult dependently on the applying method to form an alignment-layer-forming layer excellent in planarity. Moreover, if the content by percentage is smaller than the range, a load for drying the solvent increases so that the applying velocity may not be adjusted into a desired range.

The solvent used in the alignment-layer-forming coating solution in the step is not particularly limited as far as the solvent is a solvent in which the optical alignment material and others can each be dissolved into a desired concentration. Examples thereof include hydrocarbon solvents such as benzene and hexane; ketone solvents such as methyl ethyl ketone, methyl isobutyl ketone, and cyclohexanone; ether solvents such as tetrahydrofuran, 1,2-dimethoxyethane, and propylene glycol monoethyl ether (PGME); halogenated alkyl solvents such as chloroform, and dichloromethane; ester solvents such as methyl acetate, ethyl acetate, butyl acetate, and propylene glycol monomethyl ether acetate; amide solvents such as N,N-dimethylformamide; sulfoxide solvents such as dimethylsulfoxide; anone solvents as cyclohexanone; and alcohol solvents such as methanol, ethanol, and propanol. However, the solvent is not limited thereto. About the solvent used in the step, a single species thereof may be used, or two or more species thereof may be used in a mixture form.

The method for applying the alignment-layer-forming coating solution in the step is not particularly limited as far as the method is a method enabling the resultant to attain a desired planarity. Specific examples of the applying method include gravure coating, reverse coating, knife coating, dip coating, spray coating, air knife coating, spin coating, roll coating, printing, dip pulling, curtain coating, die coating, casting, bar coating, extrusion coating, and E-type painting methods.

The thickness of a coated film resulting from the alignment-layer-forming coating solution is not particularly limited as far as the thickness is within a range enabling the coated film to attain a desired planarity. Usually, the thickness is preferably from 0.1 to 50 μm, in particular preferably from 0.5 μm to 30 μm, and more preferably from 0.5 μm to 10 μm.

The method for drying the coated film resulting from the alignment-layer-forming coating solution may be an ordinarily usable drying method, such as a heat drying method, a reduced-pressure drying method, or a gap drying method. The drying method in the step is not limited to any single method. Thus, for the method, multiple manners may be adopted, for example, an embodiment may be adopted in which the drying method is successively changed in accordance with the remaining amount of the solvent.

Furthermore, the method for drying the coated film resulting from the alignment-layer-forming coating solution may be a method of blowing drying wind adjusted to a constant temperature onto the coated film. When such a drying method is used, the velocity of the dry wind-blown onto the coated film is preferably 3 m/second or less, and in particular preferably 0.5 m/second or less.

The long-alignment-film-forming film formed in the step contains at least the transparent film substrate and the alignment-layer-forming layer. If necessary, the film may have an intermediate layer (for example, a layer obtained by curing a crosslinkable monomer such as pentaerythritol triacrylate (PETA) and having a thickness of about 1 μm) in order to improve the adhesiveness between the transparent film substrate and the alignment-layer-forming layer, and improve the film in barrier performance for preventing the shift of components, such as a plasticizer, from the transparent film substrate to the alignment-layer-forming layer, or the shift of the optical alignment material contained in the alignment-layer-forming layer to the transparent film substrate.

(2) Exposing Step

The exposing step in the invention is a step involving a first exposing processing of feeding the long-alignment-film-forming film continuously, and simultaneously irradiating the alignment-layer-forming layer with polarized ultraviolet rays, and a second exposing processing of irradiating the resultant with polarized ultraviolet rays different in polarization direction from those radiated in the first exposing processing, in which in at least one of the first and second exposing processing, the polarized ultraviolet rays are patternwise radiated onto the alignment-layer-forming layer.

In the step, the method for feeding the long-alignment-film-forming film is not particularly limited as far as the method is a method capable of feeding the long-alignment-film-forming film continuously. Thus, the method may be a method using an ordinary feeding unit. Specific examples thereof include a method using an unwinding unit for supplying the long-alignment-film-forming film in a roll form, a winding unit for winding the long-alignment-film-forming film and a long patterned alignment film, or the like; and a method using a belt conveyer, a feeding roll, or the like. The method may be a method using a floating-type feeding bed for feeding the long-alignment-film-forming film in a floating state by discharge and suction of air.

As far as the method is a method capable of feeding the long-alignment-film-forming film continuously and stably, it is not particularly limited whether or not a tension is applied to the long-alignment-film-forming film when the film is fed. Preferably, the film is fed preferably in the state that a predetermined tension is applied thereto. This case makes it possible to feed the film continuously and more stably.

When the feeding unit used in the step is arranged at a position where polarized ultraviolet rays are radiated onto the long-alignment-film-forming film, the color of the feeding unit is preferably a color on which the polarized ultraviolet rays transmitted through the long-alignment-film-forming film are not reflected. Specifically, the color is preferably black. The method for making the feeding unit black is, for example, a method of subjecting the surface thereof to chromium treatment.

The shape of the feeding roll in the step is not particularly limited as far as the shape is a shape enabling the long-alignment-film-forming film to be stably fed. When the feeding roll is arranged at a position where polarized ultraviolet rays are radiated onto the long-alignment-film-forming film, it is preferred that the shape makes it possible to keep a constant distance between the front surface of the alignment-layer-forming layer of the long-alignment-film-forming film and the exposing unit. Usually, the shape is a completely round shape.

The respective polarization directions of polarized ultraviolet rays radiated in the first exposing processing and the second exposing processing in the step may be polarization directions along which the rodlike compound in the first alignment region and that in the second alignment region are caused to be arranged, respectively.

Specifically, when the optical alignment material exhibits alignment regulating force for arranging the rodlike compound in a direction along the polarization direction of the polarized ultraviolet rays, the respective directions of the polarized rays radiated in the first and second exposing processings can be each made identical with a direction along which the rodlike compound is caused to be arranged.

The polarized ultraviolet rays radiated in the step may or may not undergo light collection. When the above-mentioned pattern-radiation is applied to the long-alignment-film-forming film on the feeding roll as will be detailed later, that is, when a difference is generated in the distance between the light source of the polarized ultraviolet ray and the ultraviolet-ray-radiated-spot inside a region where the polarized ultraviolet rays are to be radiated, it is preferred that the polarized ultraviolet rays undergo light collection in the feeding direction. This case makes it possible to decrease an effect based on the distance from the light source to form the alignment regions with a good pattern-precision.

Incidentally, the method for such a light collection may be an ordinarily usable method, for example, a method using a light collecting reflector or light collecting lens having a desired shape. In the invention, the method is preferably a method of making the polarized ultraviolet rays parallel to a direction (width direction) orthogonal to the feeding direction. The method for the parallelization may be an ordinarily usable method, for example, a method using a light collecting reflector or light collecting lens having a desired shape.

The wavelength of the polarized ultraviolet rays radiated in the step is appropriately set in accordance with the optical alignment material, and others, and may be a wavelength usable when an ordinary optical alignment material is caused to exhibit alignment regulating force. Specifically, the wavelength of the used radiated light is preferably from 210 nm to 380 nm, more preferably 230 nm to 380 nm, and even more preferably from 250 nm to 380 nm.

Examples of a light source of such ultraviolet rays include low-pressure mercury lamps (a sterilizing lamp, a fluorescent chemical lamp, and a black light), high-pressure discharge lamps (a high-pressure mercury lamp, and a metal halide lamp), and short arc discharge lamps (a super high-pressure mercury lamp, a xenon lamp, and a mercury xenon lamp). It is preferred to use, among these light sources, a metal halide lamp, a xenon lamp, a high-pressure mercury lamp, or some other.

The method for generating the polarized ultraviolet rays radiated in the step is not particularly limited as far as the method is a method capable of radiating the polarized ultraviolet rays stably. The method may be a method of radiating ultraviolet rays through a polarizer that can transmit only polarized light rays having some direction.

The polarizer may be a polarizer usable ordinarily for the generation of polarized light. Examples thereof include a wire grid type polarizer having slit-form openings, and a polarizer making use of a polarized-light-separating method using a Brewster's angle made by laminating multiple quartz plates onto each other, or a polarized-light-separating method using a Brewster's angle of a film made of vapor-deposited layers different from each other in refractive index.

The irradiance of the polarized ultraviolet rays radiated in the step is not particularly limited as far as the irradiance is an irradiance making it possible to form each of the alignment regions that has a desired alignment regulating force. When the wavelength is, for example, 310 nm, the irradiance is preferably from 5 mJ/cm² to 500 mJ/cm², more preferably from 7 mJ/cm² to 300 mJ/cm², and even more preferably from 10 mJ/cm² to 100 mJ/cm². The irradiance makes it possible to form each of the alignment regions that has a sufficient alignment regulating force.

The irradiation distance of the polarized ultraviolet rays in the step, that is, the distance in the feeding direction of a long-alignment-film-forming film that receives the radiation of the polarized ultraviolet rays is not particularly limited as far as the distance permits the above-mentioned irradiance to be attained in each of the exposing processing. The irradiation distance may be appropriately set in accordance with the line velocity and others.

When the irradiation distance is short in the step, the advantage is produced that the pattern precision can easily be made high. When the irradiation distance is long, the advantage is produced that even when the line velocity is large, an alignment region having a sufficient alignment regulating force can be formed.

The method for making the irradiation distance long may be a method of pluralizing the number of times of the radiation of the polarized ultraviolet rays in each of the exposing processing, or widening the irradiation area into the feeding direction.

The method for radiating the polarized ultraviolet rays in the first and second exposing processings is not particularly limited as far as the method is a method in which the polarized ultraviolet rays are patternwise radiated onto the alignment-layer-forming layer in at least one of these processing, and is further a method capable of forming first and second alignment regions which show different directions along each of which the rodlike compound is caused to be arranged. Specifically, the method may be a method in which the first exposing processing is full-surface-radiation and the second exposing processing is pattern-radiation (a first embodiment), in which the first exposing processing is pattern-radiation and the second exposing processing is full-surface-radiation (a second embodiment), or in which the first exposing processing is pattern-radiation and the second exposing processing is pattern-radiation (a third embodiment). In the case of the first embodiment, the first and second alignment regions can be formed by using, as the alignment-layer-forming layer, a layer containing a material capable of changing alignment regulating force reversibly, such as a photo isomerization material. Specifically, as illustrated in FIGS. 8A to 8C, full-surface-radiation is performed as the first exposing processing (FIG. 8A), and next pattern-radiation is performed, using polarized ultraviolet rays different in polarization direction from those used in the first exposing processing (FIG. 8B). In this way, first and second alignment regions can be formed (FIG. 8C).

In the case of the second embodiment, the first and second alignment regions can be formed by using, as the alignment-layer-forming layer, a layer containing a material incapable of changing alignment regulating force reversibly, such as a photoreactive material (such as a photo-dimerization material). Specifically, as has been illustrated in FIGS. 5A to 5D, pattern-radiation is performed as the first exposing processing (FIG. 5B), and next full-surface-radiation is performed as the second exposing processing, using polarized ultraviolet rays different in polarization direction from those used in the first exposing processing (FIG. 5C). In this way, first and second alignment regions can be formed (FIG. 5D).

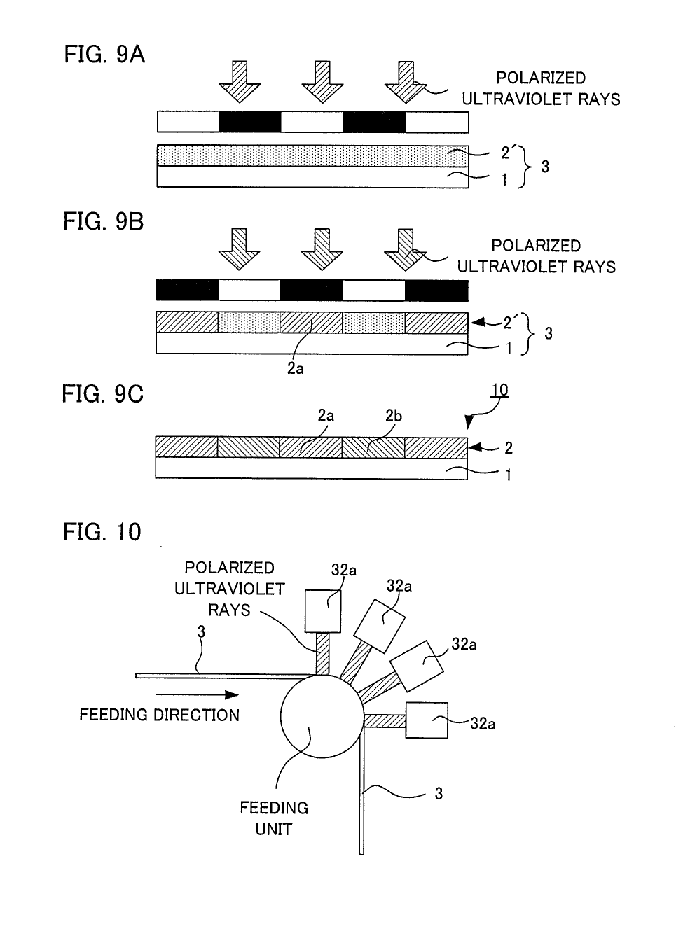

In the case of the third embodiment, the first and second alignment regions can be formed by using, as the alignment-layer-forming layer, a layer containing a material capable or incapable of changing alignment regulating force reversibly. Specifically, as illustrated in FIGS. 9A to 9C, pattern-radiation is performed as the first exposing processing (FIG. 9A), and next pattern-radiation is performed in a region different from the region irradiated in the first exposing processing, using polarized ultraviolet rays different in polarization direction from those used in the first exposing processing (FIG. 9B). In this way, first and second alignment regions can be formed (FIG. 9C).

Reference signs in FIGS. 8 to 9 represent the same members as in FIG. 1, respectively. Thus, description thereabout is omitted herein.

In the present step, it is preferred that one of the first and second exposing processing is pattern-radiation while the other is full-surface-radiation. The second embodiment is particularly preferred, in which the first exposing processing is pattern-radiation while the second exposing processing is full-surface-radiation. In a case where the other is full-surface-radiation, facilities for performing the exposing step can be made simple to form, easily at low costs, the first and second alignment regions, where the rodlike compound can be arranged in directions different from each other.

Furthermore, since the first and second exposing processes do not require pattern matching, this case makes it possible to form easily the first and second alignment regions good in pattern precision.

Additionally, the method of the second embodiment makes it possible to use, as the material constituting the alignment-layer-forming layer, a photoreactive material as described above, which is excellent in alignment-regulating-force-stability over time.

The method for performing (each of) the pattern-radiation(s) in the step is not particularly limited as far as the method is a method capable of radiating polarized ultraviolet rays with a good pattern precision. It is preferred that the pattern-radiation is performed on the feeding unit for feeding the long-alignment-film-forming film, that is, that the exposing part and the feeding unit for performing the pattern-radiation are arranged to apply the pattern-radiation onto the long-alignment-film-forming film on the feeding unit. It is particularly preferred that the feeding unit for feeding a region of the long-alignment-film-forming film that receives the pattern-radiation is a feeding roll, that is, that the pattern-radiation is applied onto the long-alignment-film-forming film on a feeding roll. This case makes it possible to keep a constant distance stable between the light source and the long-alignment-film-forming film to form, with a good precision, the first and second alignment regions, where the rodlike compound can be arranged into directions different from each other. The case also makes it possible to keep a constant distance stable easily between the light source and the long-alignment-film-forming film by use of the feeding roll.

In the case of performing the pattern-radiation in the step to make the irradiation distance long, specifically, in the case of pluralizing the number of times of radiation of polarized ultraviolet rays in each of the exposing processing or widening the irradiation area into the feeding direction to attain the pattern-radiation, the method for the pattern-radiation is not particularly limited as far as the method is a method capable of forming, with a good pattern precision, the patterned alignment region formed in each of the exposing processing. Preferably, the method is a method of performing the individual ray-patternwise-radiating operations in each of the exposing processing on the same feeding unit. In other words, it is preferred to arrange one or more exposing units and one or more feeding units for performing each of the exposing processing in such a manner that the ray-patternwise-radiating operations are applied to the long-alignment-film-forming film on the same feeding unit. When the ray-patternwise-radiating operations are made on the same feeding unit, the long-alignment-film-forming film that is being fed can be prevented from being vibrated or shifted in the width direction. Thus, polarized ultraviolet rays can be radiated thereto with a good pattern precision.

Specifically, when the number of times of the ray-patternwise-radiation in each of the pattern-radiations is plural, it is preferred that the multiple ray-radiating operations performed in the pattern-radiation are attained on the same feeding unit, that is, that the pattern-radiations are each multiple ray-patternwise-radiating operations, and further one or more exposing units and one or more feeding units are arranged in such a manner that the ray-patternwise-radiating operations, in each of the exposing processing, are attained on the same feeding unit. When the ray-patternwise-radiating operations, in each of the exposing processing, are attained on the same feeding unit, in each of pattern-radiating-operation-intervals included in the ray-patternwise-radiating operations the pattern position is easily matched with the position of the long-alignment-film-forming film. Thus, the first and second alignment regions can be formed with a good pattern precision. Even when the irradiance is short according to one ray-patternwise-radiating operation, a sufficient irradiance can be attained by the multiple ray-radiating operations onto the same spot. Thus, the long-alignment-film-forming film can be fed at a high velocity.

FIG. 10 is an explanatory view illustrating an example in which when the first exposing processing is a processing of performing multiple operations of ray-patternwise-radiation from multiple first exposing parts 32a, the ray-patternwise-radiating operations are attained on the same feeding unit.

When both of the first and second exposing processings are pattern-radiations (the third embodiment), the method for performing the pattern-radiations may be a method of making respective patterning-operations in both of the processings on different feeding units. It is however preferred to perform the respective pattern-radiations of both the processings on the same feeding unit, that is, to arrange one or more exposing units and one or more feeding units to apply the first and second exposing parts for performing the first and second exposing processings onto the long-alignment-film-forming film on the same feeding unit. When the pattern-radiations are performed on the same feeding unit, the positions of patterns thereof are easily matched with the long-alignment-film-forming film between the first and second exposing processings. Thus, the first and second alignment regions can be formed with a good pattern precision.

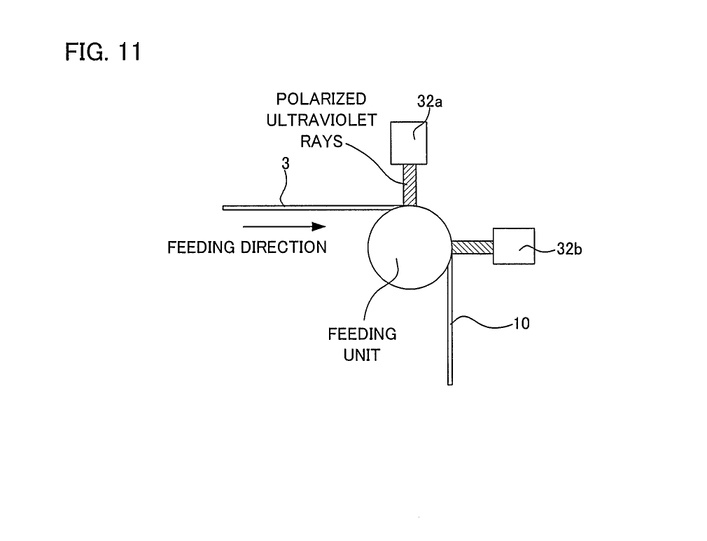

FIG. 11 is an explanatory view illustrating an example in which the first and second exposing processings are pattern-radiations such that polarized ultraviolet rays are patternwise radiated from first and second exposing parts 32a and 32b, respectively, and further the respective pattern-radiations in both the processings are attained on the same feeding unit.

When both of the first and second exposing processings are, in the present step, pattern-radiations as in the third embodiment, patterns of the pattern-radiations of the first and second exposing processings may have a region not irradiated with any polarized ultraviolet ray (non-irradiated region) between the first and second alignment regions.

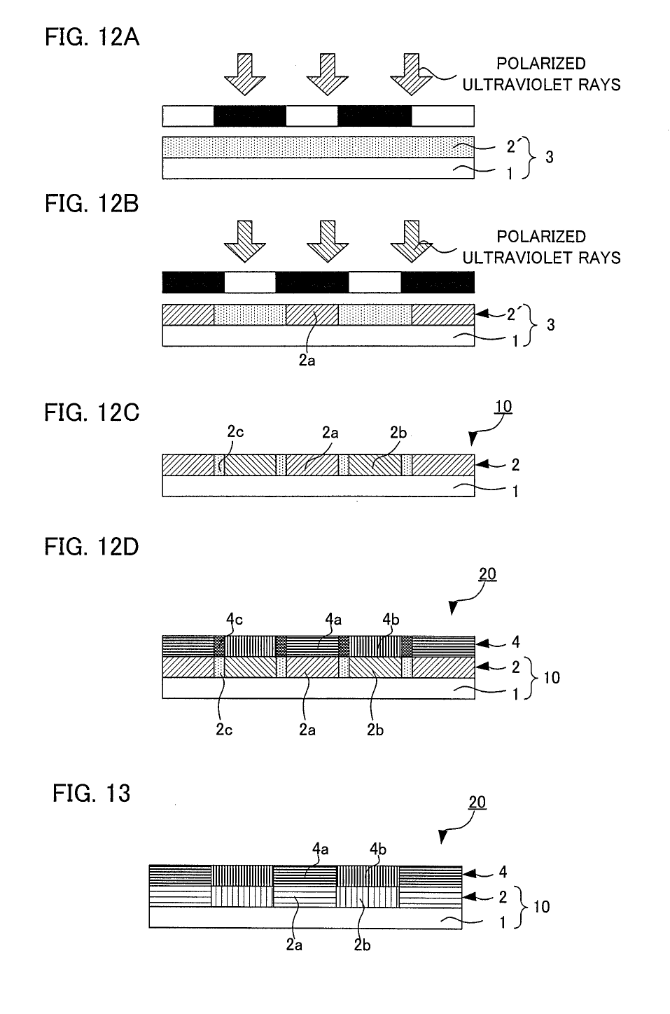

FIGS. 12A to 12D are a process chart illustrating an example of the case of forming non-irradiated regions. As illustrated in FIGS. 12A to 12D, in both of first and second exposing processings, a mask is used which has light-shielding portions where the radiation of polarized ultraviolet rays is blocked (FIGS. 12A to 12B) to make it possible to form non-irradiated regions 2c (non-alignment regions 2c) between first and second alignment regions when these are viewed in plane, as illustrated in FIG. 12C.

Incidentally, in the non-irradiated regions 2c, its optical alignment material is not irradiated with the polarized ultraviolet rays, so that these regions are non-alignment regions where alignment regulating force has not been exhibited. The rodlike compound, having refractive index anisotropy, formed on the non-alignment regions can be made into buffer regions that are in a state that the rodlike compound has not been aligned (the alignment directions of individual molecules of the rodlike compound are distributed to be at random). Specifically, as illustrated in FIG. 12D, the following is attained in the case of forming an retardation layer onto an alignment layer 2 made of a pattern that first alignment regions 2a, non-alignment regions 2c and second alignment regions 2b are, in this order, arranged or repeated one or more times when viewed in plane, so as to contain the non-alignment regions: the retardation layer 4 is made of a pattern such that first retardation regions 4a positioned just on the first alignment regions 2a, buffer regions 4c positioned just on the non-irradiated regions 2c (the regions may be referred to as non-alignment regions 2c when understood as a production-process-resulting product), and the second retardation regions 4b just on the second alignment regions 2b are, in this order, arranged or repeated one or more times when viewed in plane. The structure of the retardation layer when viewed in plane is a structure, in which any one of the buffer regions 4c, in the form of a narrow-width band, is sandwiched between one of the first retardation regions 4a and the (adjacent) second retardation regions 4b. The width of the non-alignment regions (non-irradiated regions) 2c or the buffer regions 4c may be adjusted into the range of about 0.1 μm to 10 μm. In a resultant long patterned retardation film 20, the following is caused when the pattern of the retardation layer 4 when viewed in plane is a pattern such that first retardation regions 4a, a buffer regions 4c and a second retardation regions 4b are, in this order, arranged or repeated one or more times: the vicinity of boundary lines between the first and second retardation regions 4a and 4b becomes obscure images of transmitted light to reduce moire (striped pattern) based on interference between the cycle period of the pixels and that of the first and second retardation regions 4a and 4b. Consequently, produced is an advantageous effect that no moire are generated, or that even when moire are generated, the level thereof is reduced.

Reference signs in FIGS. 12A to 12D represent the same members as in FIG. 1, respectively. Thus, description thereabout is omitted herein.

The method for forming each of the patterns in the present step is not particularly limited as far as the method is a method of radiating polarized ultraviolet rays into a desired pattern. The method is usually a method of arranging, between the long-alignment-film-forming film and the light source, a mask having openings through which polarized ultraviolet rays are transmitted only into a desired pattern form.

The material constituting the mask in the step is not particularly limited as far as the material is a material capable of forming desired openings in a product of the material. The material may be any metal that is hardly deteriorated by ultraviolet rays, or quartz. In the step, the mask is preferably a mask in which Cr is patternwise vapor-deposited on synthetic quartz. This mask is excellent in dimensional stability against a change in temperature or humidity, and others so that the alignment regions can be formed in the alignment-layer-forming layer with a good pattern precision.

The method for performing the full-surface-radiation in the present step is not particularly limited as far as the method is method capable of radiating polarized ultraviolet rays stably into a predetermined scope. It is preferred to apply the full-surface-radiation to the long-alignment-film-forming film between members of the feeding unit. It is particularly preferred to apply the full-surface-radiation to the long-alignment-film-forming film positioned between feeding rolls. This case makes it possible to attain low costs. The case also makes it possible to make the timing of performing the exposing step highly flexible.

When polarized ultraviolet rays are radiated onto the alignment-layer-forming layer in the step, it is preferred to make temperature-adjustment to make the temperature of the alignment-layer-forming layer constant. This case makes it possible to form the alignment regions with a good precision.

In the step, the temperature of the alignment-layer-forming layer is adjusted more preferably in the range of 15° C. to 90° C., and even more preferably 15° C. to 60° C.

The method for the temperature-adjustment may be a method using a temperature-adjusting instrument such as an ordinary heating/cooling instrument. The method is specifically a method using an air blower for sending air having a certain temperature, or a method using, as the feeding unit, a temperature-adjustable feeding unit, and is more specifically a method using a temperature-adjustable feeding roll or belt conveyer.

6. Usage

The long patterned alignment film of the invention may be used for, for example, a patterned retardation film usable in a three-dimensional display device. The long patterned alignment film can be in particular preferably used to form patterned retardation films required to be easily mass-produced.

B. Long Patterned Retardation Film

The following will describe the long patterned retardation film of the invention.

The long patterned retardation film of the invention comprises: the long patterned alignment film detailed above, and a retardation layer formed on the alignment layer of the long patterned alignment film, and containing a rodlike compound which has a refractive index anisotropy.

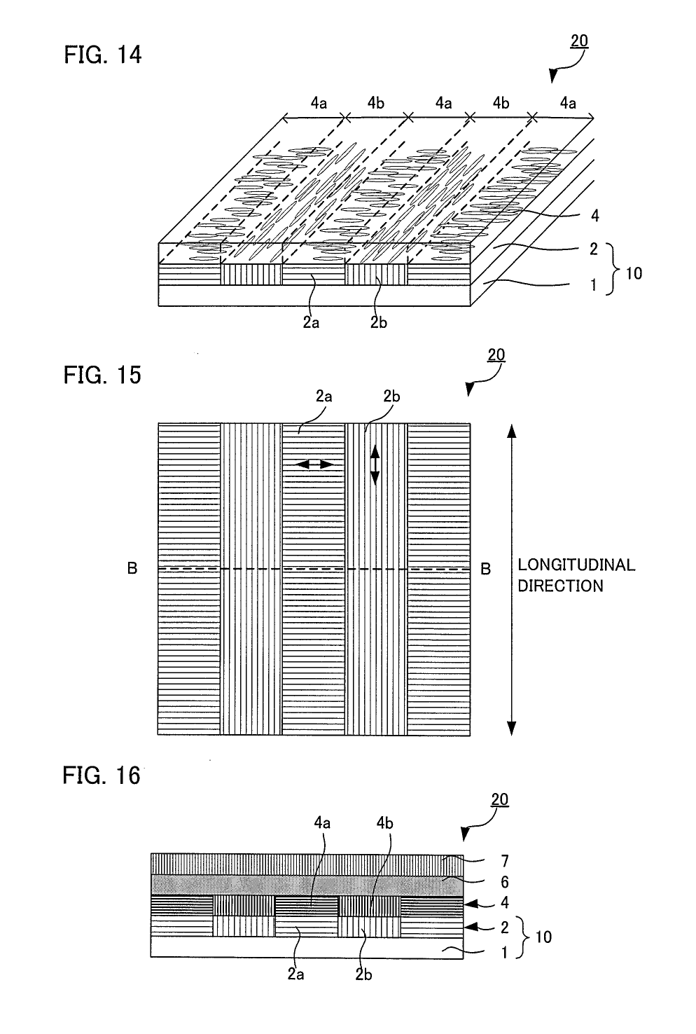

Referring to some of the drawings, the long patterned retardation film of the invention is described. FIG. 13 is a sectional view taken on line B-B in FIG. 15, FIG. 14 is a perspective view taken on line B-B in FIG. 15, and FIG. 15 is a schematic plan view illustrating an example of the long patterned retardation film of the invention. As illustrated in FIGS. 13 to 15, a long patterned retardation film 20 of the invention comprises a long patterned alignment film 10 as described above, and a retardation layer 4 formed on an alignment layer 2 included in the long patterned alignment film 10 and containing a rodlike compound having refractive index anisotropy. The retardation layer 4 has first retardation regions 4a and second retardation regions 4b having the same patterns as first alignment regions 2a and second alignment regions 2b as describe above, respectively. The rodlike compound is arranged along respective alignment regulating forces which these alignment regions have.

Incidentally, in FIG. 15, the illustration of the retardation layer is omitted for making the description easy. In this example, the alignment regulating force which the first alignment regions have is force for arranging the rodlike compound in a direction orthogonal to the longitudinal direction while the force which the second alignment regions have is force for arranging the rodlike compound in a direction parallel to the longitudinal direction.

According to the invention, the long patterned retardation film has the above-mentioned long patterned alignment film, and this matter makes it possible to render this long patterned retardation film a film having a first retardation region and a second retardation region in which the respective arranging directions of the rodlike compound are different from each other.

It is therefore possible to form easily a large number of patterned retardation films applicable to three-dimensional display devices.

Moreover, the long patterned retardation film is long, and thus the production process of the patterned retardation can be made high in flexibility.

The long patterned retardation film of the invention comprises at least the long patterned alignment film detailed above, and a retardation layer.

Hereinafter, each of the constituents of the long patterned retardation film of the invention will be described in detail.

Incidentally, the long patterned alignment film is the same as described in the item “A. Long Patterned Alignment Film”. Thus, any description thereabout is omitted herein.

1. Retardation Layer

The retardation layer in the invention is a layer formed on the above-mentioned alignment layer, and contains a rodlike compound having refractive index anisotropy, thus giving a retardation property to the long patterned retardation film of the invention. In the invention, the above-mentioned patterned alignment film, that is, the alignment layer having the above-mentioned characteristics is formed; thus, in the retardation layer in the invention, its first and second retardation regions are formed in the same pattern as formed in the above-mentioned first and second alignment regions, respectively, and further the rodlike compound is arranged in directions along respective alignment regulating forces which the individual alignment regions have.

The retardation layer used in the invention contains the rodlike compound, which will be detailed later, thus exhibiting a retardation property. As a result, the degree of the retardation property is decided dependently on the kind of the rodlike compound and the thickness of the retardation layer. Consequently, the thickness of the retardation layer used in the invention is not particularly limited as the thickness is within a range enabling the retardation layer to attain a predetermined retardation property. The thickness is appropriately decided in accordance with a use purpose of the long patterned retardation film of the invention, and others. In the retardation layer in the invention, the first and second retardation regions are substantially equal to each other in thickness. The thickness of the retardation layer in the invention is preferably within such a range that the in-plane retardation of the retardation layer corresponds to λ/4. This matter makes it possible in the long patterned retardation film of the invention that linearly polarized rays transmitted through the first and second retardation regions are converted to circularly polarized rays orthogonal to each other. Thus, the long patterned retardation film of the invention is usable more suitably for a 3D display device.

When the thickness of the retardation layer in the invention is adjusted to a distance within such a range that the in-plane retardation of the retardation layer corresponds to λ/4, it is appropriately decided in accordance with the kind of the rodlike compound, which will be detailed later, what the distance is specifically set to. In the invention, the distance is usually from 0.5 μm to 2 μm when the rodlike compound is an ordinarily usable rodlike compound. However, the distance is not limited into this range.

The following will describe the rodlike compound contained in the retardation layer. The rodlike compound used in the invention has refractive index anisotropy. The rodlike compound contained in the retardation layer in the invention is not particularly limited as far as the compound is a compound capable of being regularly molecular-arranged to give a desired retardation property to the retardation layer in the invention. The rodlike compound used in the invention is preferably a liquid crystal material, which exhibits a liquid crystal property. Since the liquid crystal material is large in refractive index anisotropy, the material makes it easy to give a desired retardation property onto the long patterned retardation film of the invention.

The liquid crystal material used in the invention may be, for example, a material exhibiting a liquid crystal phase such as a nematic phase or a smectic phase. In the invention, a material exhibiting any one of these liquid crystal phases is preferably usable. It is particularly preferred to use a liquid crystal material exhibiting a nematic phase. This nematic-phase-exhibiting liquid crystal material is more easily caused to be regularly arranged than liquid crystal materials having any other liquid crystal phase.

In the invention, the nematic-phase-exhibiting liquid crystal material is preferably a material having respective spacers at both of its mesogen terminals. The material having the spacers at both of the mesogen terminals is excellent in flexibility; thus, by use of this liquid crystal material, the long patterned retardation film of the invention can be made excellent in transparency.

The rodlike compound used in the invention is preferably a compound having in the molecule thereof a polymerizable functional group, and more preferably a compound having therein a polymerizable functional group that can be three-dimensionally crosslinked. When the rodlike compound has a polymerizable functional group, the rodlike compound can be polymerized to be fixed. This can result in yielding a retardation layer excellent in arrangement stability not to be easily changed in retardation property with time. In the case of using the rodlike compound having a polymerizable functional group, the retardation layer in the invention comes to contain the rodlike compound crosslinked through the polymerizable functional group.

Incidentally, the wording “three-dimensionally crosslinked” denotes that the liquid crystal molecules are three-dimensionally polymerized to be turned to the state of having a net (network) structure.

The polymerizable functional group may be, for example, a polymerizable functional group polymerizable by effect of ultraviolet rays, ionizing radiations such as an electron beam, or heat. A typical example of the polymerizable functional group is a radical polymerizable functional group, or a cation polymerizable functional group. A typical example of the radical polymerizable functional group is a functional group having at least one addition-polymerizable ethylenically unsaturated double bond. Specific examples thereof include a vinyl group, and an acrylic group (this wording being used as a generic name of any one of acryloyl, methacryloyl, acryloyloxy and methacryloyloxy groups) which each may be substituted or unsubstituted. A specific example of the cation polymerizable functional group is an epoxy group. Other examples of the polymerizable functional group include an isocyanate group, and an unsaturated triple bond. It is preferred from the viewpoint of the process to use, among these groups, a functional group having an ethylenically unsaturated double bond.

The rodlike compound in the invention is in particular preferably a liquid crystal material, which exhibits a liquid crystal property, having at terminals of each molecules polymerizable functional groups as described above. The use of this liquid crystal material makes it possible that molecules thereof are three-dimensionally polymerized with each other to generate a net (network) structure state to form the above retardation layer that has alignment stability and is excellent in performance of exhibiting optical characteristics.

Incidentally, even when a liquid crystal material having at a single terminal of each molecule a polymerizable functional group is used, the material is crosslinked with another molecule so that the material can be stabilized in alignment.

Specific examples of the rodlike compound used in the invention include compounds represented by the formulae (1) to (17), respectively:

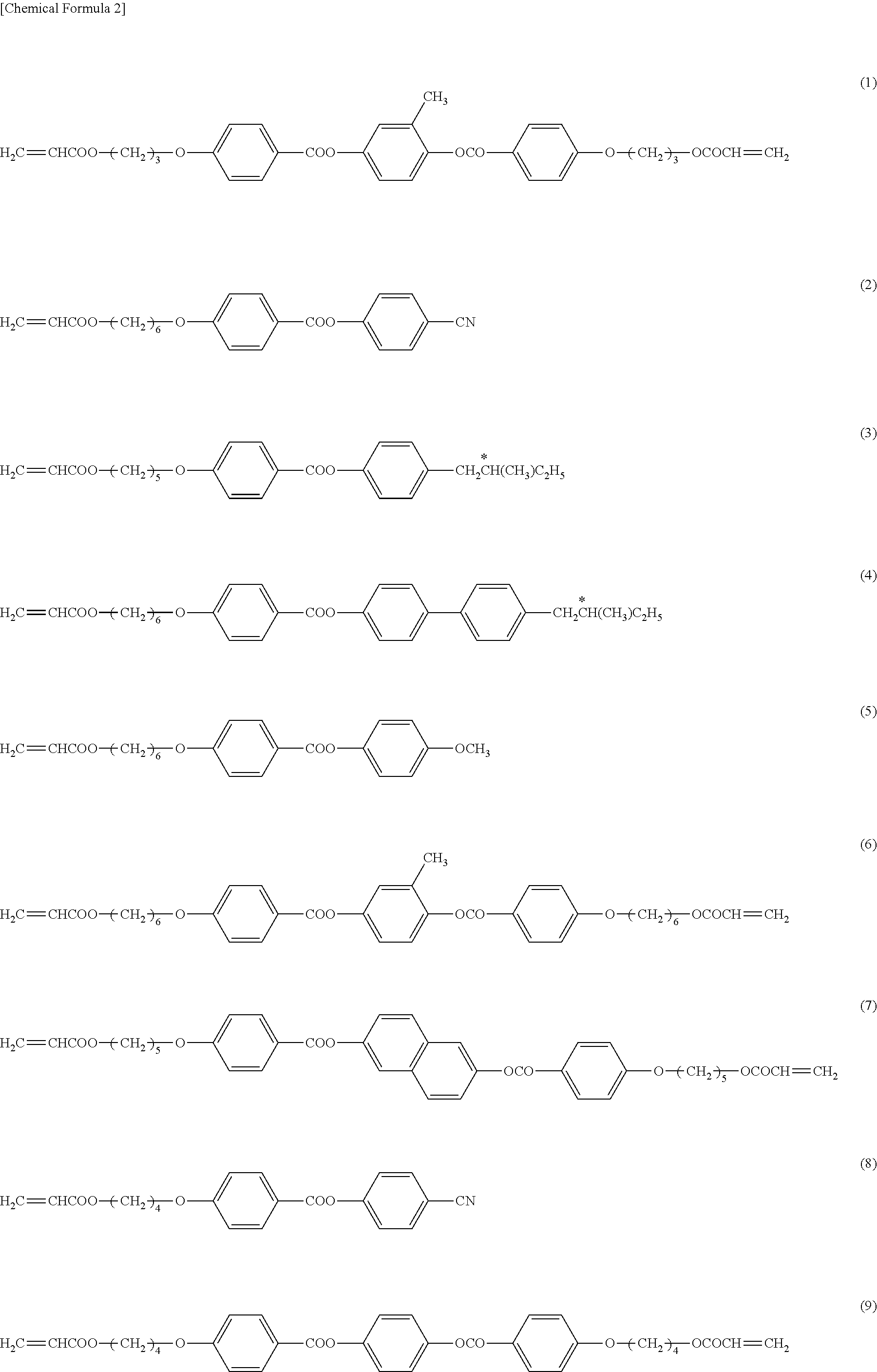

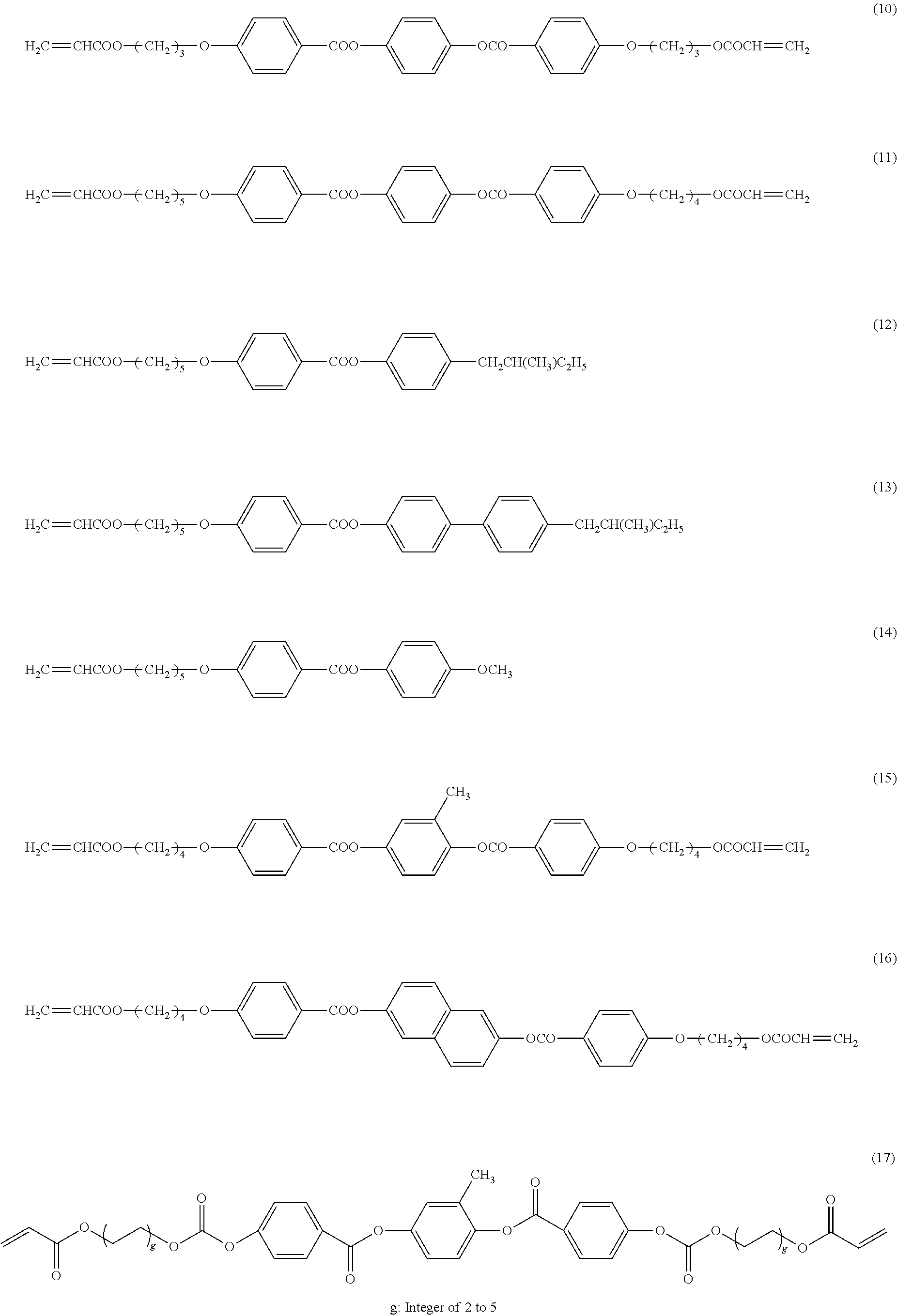

Incidentally, about the rodlike compound, only a single species thereof may be used, or two or more species thereof may be used in a mixture form. It is preferred to use a mixture of a liquid crystal material having at each of both the terminals thereof one or more polymerizable functional groups and a liquid crystal material having at a single terminal thereof one or more polymerizable functional groups since the polymerization density (crosslinkage density) and optical characteristics thereof are arbitrarily adjustable by adjusting the blend ratio between the two. It is preferred from the viewpoint of keeping the reliability to use a liquid crystal material having at each of both the terminals thereof one or more polymerizable functional groups. From the viewpoint of the alignment of the liquid crystal, it is preferred that each of the terminals has only one polymerizable functional group.

2. Long Patterned Retardation Film

(1) Other Constituents

Although the long patterned retardation film of the invention comprises at least the patterned alignment film and the retardation layer detailed above, the long patterned retardation film may comprise a different constituent if necessary. As illustrated in FIG. 16, examples of the different constituent include an adhesive layer 6 and a separator 7 each formed on a retardation layer 4.

Incidentally, the adhesive layer and the separator in the invention may be ones usable in ordinary retardation films.

(2) Long Patterned Retardation Film

The retardation film of the invention is a film having a structure in which a first retardation region and a second retardation region are patternwise formed in a retardation layer to correspond to a pattern in which first and second alignment regions as detailed above are formed. The degree of a retardation property which the first and second retardation regions have is not particularly limited, and may be appropriately decided in accordance with a use purpose of the long patterned retardation film of the invention, and others. Thus, specific numerical value ranges of the respective in-plane retardations which the first and second retardation regions exhibit are not particularly limited, either, and may be appropriately decided in accordance with the use purpose of the long patterned retardation film. When the long patterned retardation film of the invention is used to produce a 3D liquid crystal display device, the in-plane retardation value of the retardation layer corresponds preferably to λ/4. More specifically, the in-plane retardation value of the retardation layer is preferably from 100 nm to 160 nm, more preferably from 110 nm to 150 nm, and even more preferably from 120 nm to 140 nm. In the retardation layer in the invention, the respective in-plane retardation values which the first and second retardation regions exhibit are substantially equal to each other although their slow axis directions are different from each other.

Here, the in-plane retardation value is an index representing the degree of the double refractivity of a refractive index anisotropic body in the in-plane direction thereof. When the refractive index thereof in the slow axis direction, which is a direction along which the largest refractive index is exhibited among the in-plane directions, is represented by Nx, the refractive index thereof in the fast axis direction orthogonal to the slow axis direction by Ny, and the thickness of the refractive index anisotropic body in a direction perpendicular to the in-plane directions by “d”, the in-plane retardation value is a value represented by the following:

Re [nm]=(Nx−Ny)×d [nm].

The in-plane retardation value (Re value) is measurable, using, for example, an instrument, KOBRA-WR™, manufactured by Oji Scientific Instruments by a parallel Nicol rotating method. The in-plane retardation value of a microscopic area is also measureable by means of an instrument, AxoScan™, manufactured by Axometrics, Inc. (USA) using a Mueller matrix. In the present specification, any Re value denotes a value at a wavelength of 589 nm unless otherwise specified.

In the retardation layer in the invention, the pattern in which the first and second retardation regions are formed is not particularly limited, either, and may be appropriately decided in accordance with a use purpose of the long patterned retardation film of the invention, and others. Incidentally, the pattern in which the first and second retardation regions are formed is consistent with the pattern in which the first and second alignment regions are formed in the alignment layer. Thus, by selecting the pattern in which the first and second alignment regions are formed, the pattern in which the first retardation region and second retardation region are formed are simultaneously decided.

The matter that the pattern made of the first and second retardation regions is formed in the long patterned retardation film of the invention can be estimated, for example, by putting a sample into polarizing plates in a crossed Nicol state, and then verifying that bright lines and dark lines are made reverse to each other when the sample is rotated. In a case where the pattern made of the first and second retardation regions is fine at this time, it is advisable to observe the sample through a polarization microscope. The direction (angle) of the slow axis inside each of the patterned regions may be measured with AxoScan™ described above.

3. Method for Producing Long Patterned Retardation Film

The method for producing the long patterned retardation film of the invention is not particularly limited as far as the method is a method capable of forming stably a long patterned retardation film in which the transparent film substrate, alignment layer and retardation layer detailed above are laminated onto each other in this order. The method may be a method for producing an ordinary retardation film.

A specific example thereof is a method of applying a retardation-layer-forming coating solution containing a rodlike compound onto an alignment layer of a patterned alignment film as detailed above to arrange the rodlike compound contained in the resultant coated film along alignment regulating forces which the alignment regions contained in the alignment layer have, and optionally subjecting the resultant to curing treatment to form a retardation layer.

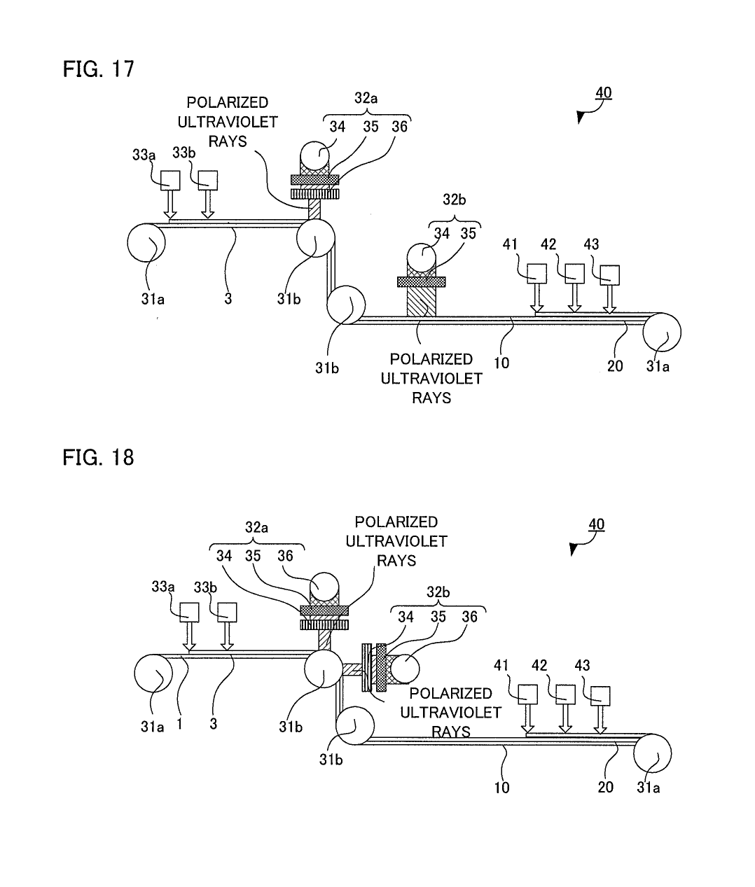

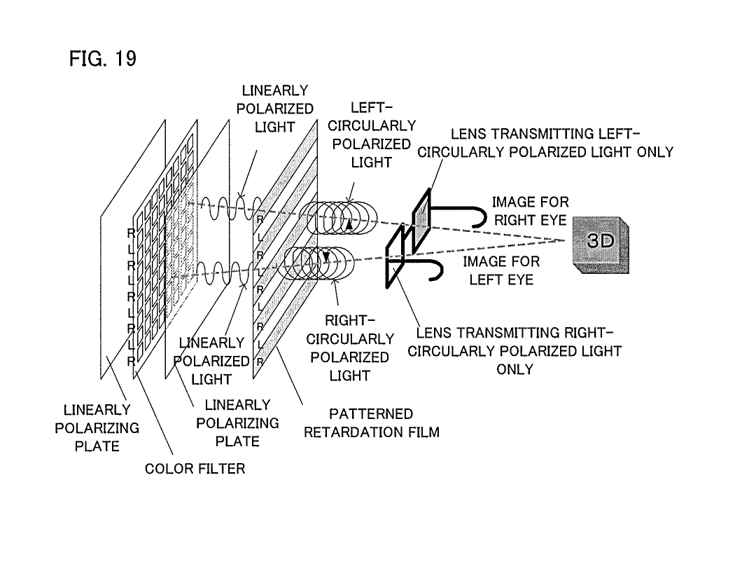

Referring to some of the drawings, a description is made about a long-patterned-retardation-film producing apparatus used to form such a long patterned retardation film of the invention. FIGS. 17 and 18 are each a schematic view illustrating an example of the long-patterned-retardation-film producing apparatus. As illustrated in each of FIGS. 17 and 18, a long-patterned-retardation-film producing apparatus 40 has, besides the above-mentioned long-patterned-alignment-film producing apparatus, an applicator 41 for applying a retardation-layer-forming coating solution containing a rodlike compound having refractive index anisotropy onto an alignment layer of a long patterned alignment film 10 formed by this producing apparatus, an aligning unit 42 for aligning the rodlike compound contained in a coated film resulting from the retardation-layer-forming coating solution along different arranging directions of first and second alignment regions contained in the alignment layer, and a curing unit 43 for radiating ultraviolet rays to cure the rodlike compound, so as to produce a long patterned retardation film 20.

The retardation-layer-forming coating solution in the invention is usually composed of a rodlike compound and a solvent, and may optionally a different compound. The solvent used in the retardation-layer-forming coating solution is not particularly limited as far as the solvent is a solvent in which the rodlike compound can be dissolved in a desired concentration, and is further a solvent which does not corrode the transparent film substrate. Specifically, the solvent may be the same as described in the item “A. Long Patterned Alignment Film”.

The content by percentage of the rodlike compound in the retardation-layer-forming coating solution is not particularly limited as far as the content is within a range enabling the viscosity of the retardation-layer-forming coating solution to be set to a desired value in accordance with the method of applying the retardation-layer-forming coating solution onto the transparent film substrate, and others. In the invention, the content by percentage is preferably from 5% by mass to 40% by mass, and more preferably from 10% by mass to 30% by mass of the retardation-layer-forming coating solution.

The different compound is not particularly limited as far as the compound is a compound which does not damage the arrangement order of the rodlike compound in the retardation layer used in the invention. Examples of the different compound used in the invention include a polymerization initiator, a polymerization inhibitor, a plasticizer, a surfactant, and a silane coupling agent.

When the above-mentioned polymerizable liquid crystal material is used as the rodlike compound, it is preferred to use, as the different compound, a polymerization initiator or a polymerization inhibitor.

The polymerization initiator used in the invention may be a known ordinary compound, such as a benzophenone based compound. When the polymerization initiator is used, a polymerization initiating aid may be used together. Examples of the polymerization initiating aid include tertiary amines such as triethanolamine and methyldiethanolamine, and benzoic acid derivatives such as 2-dimethylaminoethylbenzoic acid, and ethyl 4-dimethylamidebenzoate. However, the aid is not limited thereto.

The applying method for applying the retardation-layer-forming coating solution onto the transparent film substrate, and the method for drying the coated film resulting from the retardation-layer-forming coating solution are not particularly limited as far as the methods enable the coated film to attain a desired planarity. These methods may be the same as described in the item “A. Long Patterned Alignment Film”.

In the invention, the method for arranging the rodlike compound contained in the coated film, resulting from coating the retardation-layer-forming coating solution onto the alignment layer, along the alignment regulating forces, which the alignment regions contained in the alignment layer have, is not particularly limited as far as the method is a method capable of arranging the rodlike compound into desired directions. The method may be an ordinary method. When the rodlike compound is a liquid crystal material, a method is used in which the coated film is heated to the liquid-crystal-phase-forming temperature of the rodlike compound, or higher.

When a polymerizable material is used as the rodlike compound, the method for polymerizing the polymerizable material is not particularly limited, and may be appropriately decided in accordance with the kind of a polymerizable functional group which the polymerizable material has.

4. Usage

The long patterned retardation film of the invention may be used for, for example, a patterned retardation film used in a three-dimensional display device. The long patterned retardation film can be in particular preferably used to form patterned retardation films required to be easily mass-produced.

The invention is not limited to the above-mentioned embodiments. The embodiments are exemplary. Thus, as far as any embodiment that has substantially the same structure and produces the same advantageous effects as the technical subject matter recited in the claims of the invention is included in the technical scope of the invention.

### EXAMPLES

Hereinafter, the invention will be specifically described by way of working examples thereof, and comparative examples.

### Example 1

Prepared was a TAC (cellulose triacetate) film (FUJITAC™, manufactured by Fuji Film Corporation) having a thickness of 80 μm. The film had, on a surface thereof, an AG (antiglare) film (manufactured by Dai Nippon Printing Co., Ltd.) having a haze value of 10 to 15 and obtained by dispersing transparent particles into a transparent resin to coat. A coating solution containing PETA and a photopolymerization initiator was painted onto the surface of the TAC film that was opposite to the AG surface. The resultant coated film was cured by UV to form an intermeddle layer (block layer) having a thickness of 1 μm. In this way, a roll-form original film, 1 m in width and 2000 m in length, was prepared. The apparatus illustrated in FIG. 6 was used to apply an alignment-layer-forming coating solution containing a photo-dimerization reaction type optical alignment material (trade name: ROP-103, manufactured by Rolic Technologies Ltd.) as an optical alignment material onto the intermediate layer side of the original film, and then the resultant was dried to form an alignment-layer-forming layer having a thickness of 0.1 μm. Polarized ultraviolet rays transmitted through a wire grid (their polarization axis was along a direction having an angle of 45 degrees to the feeding direction of the film) were radiated thereonto through a mask in which chromium was used to form, onto a synthetic quartz piece, a pattern of stripes having a width of 500 μm in a direction parallel to the feeding direction of the original film. Next, polarized ultraviolet rays (their polarization axis was along a direction having an angle of −45 degrees to the feeding direction of the film) were radiated through not any mask but a wire grid onto the workpiece to yield a long patterned alignment film having an alignment layer.

A liquid crystal (licrivue (registered trade name) RMS03-013C (trade name) manufactured by Merck KGaA) dissolved in a solvent was painted onto the alignment layer of the long patterned alignment film, which had been patterned, and the resultant was dried (liquid crystal alignment). The workpiece was cooled to a temperature close to room temperature, and then cured with ultraviolet rays to form a long patterned retardation film having a retardation layer having a thickness of 1 μm.

The resultant long patterned retardation film was observed through crossed Nicol state polarizing plates. As a result, it was verified through a bright and dark pattern thereof that the alignment layer was patterned.

### Example 2

A long patterned retardation film was formed in the same way as in Example 1 except that the apparatus illustrated in FIG. 7 was used to radiate, in the second polarized-ultraviolet-ray-radiation, polarized ultraviolet rays through a mask as obtained by changing the openings and the light-shielding part in the mask used in the first polarized-ultraviolet-ray-radiation from each other and that a long patterned alignment film having an alignment layer was formed. The resultant was observed through crossed Nicol state polarizing plates. As a result, substantially the same result was obtained.

### Example 3

A long patterned retardation film was formed in the same way as in Example 1 except that the apparatus illustrated in FIG. 17 was used to form this long patterned retardation film continuously from the original film. The resultant was observed through crossed Nicol state polarizing plates. As a result, substantially the same result was obtained.

### Example 4

A long patterned retardation film was formed in the same way as in Example 3 except that the apparatus illustrated in FIG. 18 was used to form this long patterned retardation film continuously from the original film. The resultant was observed through crossed Nicol state polarizing plates. As a result, substantially the same result was obtained.

### REFERENCE SIGNS LIST

1 . . . Transparent film substrate
2′ . . . Alignment-layer-forming layer
2 . . . Alignment layer
2a . . . First alignment regions
2b . . . Second alignment regions
2c . . . Non-alignment regions
3 . . . Long-alignment-film-forming film
4 . . . Retardation layer
4a . . . First retardation regions
4b . . . Second retardation regions
4c . . . Buffer regions
5 . . . Antireflective layer or antiglare layer
6 . . . Adhesive layer
7 . . . Separator
10 . . . Long patterned alignment film
20 . . . Long patterned retardation film

1-12. (canceled)

13. A long patterned alignment film, comprising an alignment layer which is in a long form and comprises an optical alignment material,
wherein the alignment layer comprises a first alignment region for causing a rodlike compound having a refractive index anisotropy to be arranged in a certain direction, and a second alignment region for causing the rodlike compound to be arranged in a direction different from the certain direction of the first alignment region.

14. The long patterned alignment film according to claim 13, wherein the alignment layer has a nonalignment region between the first alignment region and the second alignment region when viewed in plane.

15. The long patterned alignment film according to claim 13, wherein the first alignment region and the second alignment region are formed into a pattern in a form of bands parallel to each other in a longitudinal direction of the alignment film.

16. The long patterned alignment film according to of claim 13, wherein the respective directions along which the rodlike compound is caused to be arranged in the first alignment region and the second alignment region are different from each other by 90°.

17. The long patterned alignment film according to claim 16, wherein the respective directions along which the rodlike compound is caused to be arranged in the first alignment region and the second alignment region are a direction having an angle of 0° to a longitudinal direction and a direction having an angle of 90° to the longitudinal direction, respectively.

18. The long patterned alignment film according to claim 16, wherein the respective directions along which the rodlike compound is caused to be arranged in the first alignment region and the second alignment region are a direction having an angle of 45° to a longitudinal direction and a direction having an angle of 135° to the longitudinal direction, respectively.

19. The long patterned alignment film according to claim 13, wherein a transparent film substrate is formed on the alignment layer.

20. The long patterned alignment film according to claim 19, wherein an antireflective layer and/or an antiglare layer is/are formed on a surface of the transparent film substrate that is opposite to a surface on which the alignment layer is formed.

21. A long patterned retardation film, comprising:
the long patterned alignment film recited in claim 13; and
a retardation layer formed on the alignment layer of the long patterned alignment film, and comprising a rodlike compound which has a refractive index anisotropy.

22. The long patterned retardation film according to claim 21, wherein the alignment layer has a pattern in which the first alignment region, a non-alignment region and the second alignment region are, in this order, arranged or repeated one or more times when viewed in plane, and
the retardation layer has a pattern in which a first retardation region positioned just on the first alignment region, a buffer region positioned just on the non-alignment region, and a second retardation region positioned just on the second alignment region are, in this order, arranged or repeated one or more times when viewed in plane.

23. The long patterned retardation film according to claim 21, wherein an in-plane retardation value of the retardation layer corresponds to λ/4.

24. The long patterned retardation film according to claim 21, wherein an adhesive layer and a separator are, in this order, formed on the retardation layer.
